(19) United States
(12) Patent Application Publication
(10) Pub. No.: US 2016/0124223 A1
(43) Pub. Date: May 5, 2016

(54) VIRTUAL IMAGE DISPLAY APPARATUS

(71) Applicant: SEIKO EPSON CORPORATION, Tokyo (JP)

(72) Inventors: Akira SHINBO, Shiojiri-shi (JP); Osamu YOKOYAMA, Shiojiri-shi (JP); Masatoshi YONEKUBO, Hara-Mura (JP)

(21) Appl. No.: 14/884,141

(22) Filed: Oct. 15, 2015

(30) Foreign Application Priority Data
Oct. 29, 2014 (JP) 2014-220043

(51) Int. Cl. G02B 27/01; G02B 27/00; F21V 8/00

(52) U.S. Cl. CPC G02B 27/0101; G02B 6/0023; G02B 6/005; G02B 27/0037; G02B 2027/011

(57) ABSTRACT

A virtual image display apparatus includes a first light guide that not only causes a display light flux incident through a first light incident surface to repeatedly undergo internal reflection to travel in a first direction away from the first light incident surface but also causes part of the display light flux to exit to the outside through areas of a first light exiting surface that is at least one of interfaces with the outside and extends in the first direction, a first light-incident-side diffraction grating that diffracts light incident thereon to cause the diffracted light to enter the first light guide, and a first light-exiting-side diffraction grating that diffracts light incident from the first light guide.

### BACKGROUND

1. Technical Field

The present invention relates to a virtual image display apparatus.

2. Related Art

There is a known flat-panel projection display of related art that allows visual recognition of an image projected from a video projector in the form of a virtual image (see Japanese Patent No. 3,990,984, for example).

The projection display described in Japanese Patent No. 3,990,984 includes a transparent rod and transparent slab, a video projector, and two mirrors.

The transparent slab has a structure in which a plurality of float glass pieces layered on each other with glue having a selected refractive index are polished into a box-shaped slab and is so disposed that the interferences between the glue and the glass pieces are inclined to the horizontal direction by 45°. The transparent rod, which is formed in the same manner as the transparent slab described above, has a roughly rectangular cross section corresponding to the thickness dimension of the transparent slab. The video projector outputs image-forming light rays to the transparent rod via the two mirrors described above along an oblique direction that is not parallel to the rod axis of the transparent rod described above.

In the thus configured projection display, the light rays having entered the transparent rod travel through the transparent rod along the rod axis. The internally traveling light rays are partially reflected off the interfaces between the glue and the glass pieces and exit to the outside in the direction orthogonal to the light traveling direction, whereby the light rays from the transparent rod enters the transparent slab. Further, the light rays having entered the transparent slab are partially reflected off the interfaces described above, as in the transparent rod, and the light rays exit horizontally through positions according to the interfaces in the transparent slab. A viewer present in a position along the traveling direction of the light rays can view an image formed by the light rays. That is, the exit positions where the light rays outputted from the video projector exit are spread in the vertical direction by the transparent rod and in the horizontal direction by the transparent slab.

The thus configured projection display is used, for example, as a head-up display.

The projection display described in Japanese Patent No. 3,990,984 causes no problem in a case where it is used in an application in which a viewing position is fixed so that only a displayed image, which is a virtual image, is brought into focus, such as the case where the projection display is used, for example, as a head-up display.

In the configuration of the transparent slab described above, however, part of the light is reflected off the interfaces described above and reaches the viewer's eyes, resulting in the following problems in an application in which the displayed image is viewed from arbitrary viewing positions: The presence of the transparent slab is likely to be recognized; and the presence of the interfaces and the gaps between the interfaces are superimposed on the displayed image and likely to be recognized as noise.

Specifically, in the transparent slab described above, whenever the reflection occurs at each of the interfaces, the luminance of the light rays as a whole that exit via the interface decreases. As a result, the luminance of the light rays reflected off an interface on the upstream side in the traveling direction of the light rays in the transparent slab differs from the luminance of the light rays reflected off an interface on the downstream side. The difference in the luminance undesirably causes the presence of the interfaces and the gaps between the interfaces to be likely to be visually recognized and eventually results in degradation in an image viewed through the transparent slab.

To solve the problems described above, a different configuration capable of suppressing the image degradation has been desired.

### SUMMARY

An advantage of some aspects of the invention is to provide a virtual image display apparatus capable of suppressing image degradation.

A virtual image display apparatus according to an aspect of the invention includes a first light guide that not only causes a display light flux incident through a first light incident surface to repeatedly undergo internal reflection to travel in a first direction away from the first light incident surface but also causes part of the display light flux to exit to the outside through areas of a first light exiting surface that is at least one of interfaces with the outside and extends in the first direction, a first light-incident-side diffraction grating that diffracts light incident thereon to cause the diffracted light to enter the first light guide, and a first light-exiting-side diffraction grating that diffracts light incident from the first light guide.

The first light-incident-side diffraction grating may be disposed in a position where it faces the first light incident surface or may be disposed in a position where it faces the surface of the first light guide on the side opposite the first light incident surface (position where it faces first light incident surface with first light guide interposed therebetween).

In the former case, the first light-incident-side diffraction grating can be formed of a transmissive diffraction grating, and the display light flux diffracted by the first light-incident-side diffraction grating enters the first light guide through the first light incident surface and travels in the first light guide. That is, the first light-incident-side diffraction grating is a transmissive diffraction grating that diffracts light incident thereon to cause the diffracted light to enter the first light guide through the first light incident surface.

In the latter case, the first light-incident-side diffraction grating can be formed of a reflective diffraction grating, and the display light flux having entered the first light guide through the first light incident surface is incident on and diffracted by the first light-incident-side diffraction grating and travels in the first light guide. That is, the first light-incident-side diffraction grating is a reflective diffraction grating that diffracts light incident from the first light guide to cause the diffracted light to enter the first light guide.

Similarly, the first light-exiting-side diffraction grating may be disposed in a position where it faces the first light exiting surface or may be disposed in a position where it faces the surface of the first light guide on the side opposite the first light exiting surface (position where it faces first light exiting surface with first light guide interposed therebetween).

In the former case, the first light-exiting-side diffraction grating can be formed of a transmissive diffraction grating, and the display light flux having exited through the first light exiting surface is diffracted by the first light-exiting-side diffraction grating and exits out of the virtual image display apparatus. That is, the first light-exiting-side diffraction grating is a transmissive diffraction grating that diffracts light incident through the first light exiting surface to cause the diffracted light to be exit out of the virtual image display apparatus.

In the latter case, the first light-exiting-side diffraction grating can be formed of a reflective diffraction grating, and the display light flux incident on the first light-exiting-side diffraction grating while traveling in the first direction described above in the first light guide is diffracted by the first light-exiting-side diffraction grating and exits out of the first light guide through the first light exiting surface, that is, out of the virtual image display apparatus. That is, the first light-exiting-side diffraction grating is a reflective diffraction grating that diffracts light incident from the first light guide to cause the diffracted light to travel in the direction in which the diffracted light exits to the outside through the first light exiting surface.

A diffraction grating diffracts light incident thereon at a larger angle of diffraction (the angle between the diffracted light and a normal to the diffraction grating) when the wavelength of the incident light is greater. The first light-incident-side diffraction grating therefore diffracts light rays that form the incident display light flux at different angles of diffraction according to the wavelengths of the light rays. As a result, the light rays having different wavelengths travel in the first light guide in the first direction while repeatedly undergoing internal reflection at different areas. On the other hand, the first light-exiting-side diffraction grating diffracts the light rays incident from the first light guide at different angles of diffraction according to the wavelengths of the light rays. A viewer present in a position on which light outputted from the thus configured virtual image display apparatus is incident can view an image formed by the light in the form of a virtual image. When the first light guide is elongated in the first direction and the first light guide is provided with the first light-exiting-side diffraction grating elongated in the first direction, an image formed by the incident display light flux can be visually recognized in an arbitrary position in the first direction in the form of a virtual image as if it were located on the far side of the first light guide (side opposite light exiting side).

In the thus configured virtual image display apparatus, since the first light-incident-side diffraction grating diffracts light at different angles of diffraction according to the wavelengths of the light rays that form the light, the light rays having the different wavelengths travel along different optical paths in the first light guide. When the display light flux is concentrated and caused to be incident on the first light-incident-side diffraction grating, light that forms part of an image formed by the display light flux and light that forms another part of the image are allowed to travel along different optical paths in the first light guide. When the light traveling in the first light guide then travels via the first light-exiting-side diffraction grating in the course of the travel in the first light guide or after the light exits through the first light exiting surface, the light is diffracted at different angles of diffraction according to the wavelengths of light rays that form the light, whereby the light can be caused to exit out of the virtual image display apparatus in a dispersed manner and the exit angle of the light can be adjusted on a wavelength basis.

The thus configured virtual image display apparatus can prevent a change in luminance that occurs in a case where the display light flux is incident on a light guide in which a plurality of semi-transparent layers inclined to the first direction are formed (transparent slab described above, for example) and the light reflected off the semi-transparent layers is caused to exit. Therefore, a situation in which the change in luminance is visually recognized and an image formed by the exiting light is degraded can be avoided.

In the aspect described above, it is preferable that the first light-incident-side diffraction grating and the first light-exiting-side diffraction grating diffract incident light fluxes having the same wavelength at the same angle of diffraction.

According to the aspect with the configuration described above, the angle of diffraction at which a light flux incident on the first light-incident-side diffraction grating exits and the angle of diffraction at which a light flux incident on the first light-exiting-side diffraction grating exits are equal to each other when the wavelengths of the light fluxes are the same. As a result, the angle of incidence of the light flux incident on the first light-incident-side diffraction grating (angle of the incident light with respect to a normal to the light incident surface of the first light-incident-side diffraction grating) and the exit angle of the light flux that exits out of the first light-exiting-side diffraction grating (angle of the exiting light with respect to a normal to the light exiting surface of the first light-exiting-side diffraction grating) can be equal to each other. The configuration described above allows the exit angle of the light from the virtual image display apparatus to be readily adjusted and further allows the viewer to readily visually recognize an image formed by the light.

In the aspect described above, it is preferable that the virtual image display apparatus further includes a second light guide that not only causes the display light flux incident through a second light incident surface to repeatedly undergo internal reflection to travel in a second direction roughly perpendicular to the first direction but also causes part of the display light flux to exit toward the first light incident surface through areas of a second light exiting surface that is at least one of the interfaces with the outside and extends in the second direction.

According to the aspect with the configuration described above, when the first light guide is elongated in the first direction described above and the second direction described above and the second light guide, which guides the display light flux to the first light guide, is elongated in the second direction, the display light flux that travels in the second direction in the second light guide is allowed to pass through multiple areas of the second light exiting surface and enter the first light guide through the first light incident surface. The configuration described above allows the second light guide to disperse the display light flux in the second direction and cause the dispersed light to exit and further allows the first light guide to disperse the display light flux in the first direction and cause the dispersed light to exit. The range over which an image formed by the display light flux can be visually recognized can therefore be widened in the first and second directions.

In the aspect described above, it is preferable that the virtual image display apparatus further includes a second light-incident-side diffraction grating that diffracts light incident thereon to cause the diffracted light to enter the second light guide and a second light-exiting-side diffraction grating that diffracts light incident from the second light guide.

Similarly to the first light-incident-side diffraction grating, the second light-incident-side diffraction grating may be disposed in a position where it faces the second light incident surface or may be disposed in a position where it faces the surface of the second light guide on the side opposite the second light incident surface (position where it faces second light incident surface with second light guide interposed therebetween), as in the case of the first light-incident-side diffraction grating described above.

In the former case, the second light-incident-side diffraction grating can be formed of a transmissive diffraction grating, and the display light flux diffracted by the second light-incident-side diffraction grating enters the second light guide through the second light incident surface and travels in the second light guide. That is, the second light-incident-side diffraction grating is a transmissive diffraction grating that diffracts light incident thereon to cause the diffracted light to enter the second light guide through the second light incident surface.

In the latter case, the second light-incident-side diffraction grating can be formed of a reflective diffraction grating, and the display light flux having entered the second light guide through the second light incident surface is incident on and diffracted by the second light-incident-side diffraction grating and travels in the second light guide. That is, the second light-incident-side diffraction grating is a reflective diffraction grating that diffracts light incident from the second light guide to cause the diffracted light to enter the second light guide.

Similarly to the first light-exiting-side diffraction grating, the second light-exiting-side diffraction grating may be disposed in a position where it faces the second light exiting surface or may be disposed in a position where it faces the surface of the second light guide on the side opposite the second light exiting surface (position where it faces second light exiting surface with second light guide interposed therebetween).

In the former case, the second light-exiting-side diffraction grating can be formed of a transmissive diffraction grating, and the display light flux having exited through the second light exiting surface is diffracted by the second light-exiting-side diffraction grating and exits toward the first light guide. That is, the second light-exiting-side diffraction grating is a transmissive diffraction grating that diffracts light incident through the second light exiting surface to cause the diffracted light to be exit toward the first light guide.

In the latter case, the second light-exiting-side diffraction grating can be formed of a reflective diffraction grating, and the display light flux incident on the second light-exiting-side diffraction grating while traveling in the second direction described above in the second light guide is diffracted by the second light-exiting-side diffraction grating and exits toward the first light guide through the second light exiting surface. That is, the second light-exiting-side diffraction grating is a reflective diffraction grating that diffracts light incident from the second light guide to cause the diffracted light to travel in the direction in which the diffracted light exits to the outside through the second light exiting surface.

According to the aspect with the configuration described above, when the display light flux is incident on the second light-incident-side diffraction grating, light rays that form the display light flux are allowed to travel along different optical paths in the second light guide in accordance with the wavelengths of the light rays that form the display light flux and the angles of incidence of the light rays with respect to the second light-incident-side diffraction grating, as in the case of the first light-incident-side diffraction grating and the first light-exiting-side diffraction grating described above. When the light traveling in the second light guide then travels via the second light-exiting-side diffraction grating in the course of the travel in the second light guide or after the light exits through the second light exiting surface, the light is diffracted at different angles of diffraction according to the wavelengths of light rays that form the light, whereby the light can be caused to exit toward the first light guide in a dispersed manner and the exit angle of the light can be adjusted on a wavelength basis.

The display light flux caused to be incident on the first light guide is therefore allowed to be reliably exit in a dispersed manner in the second direction.

In the aspect described above, it is preferable that the second light exiting surface and the first light incident surface are disposed in positions where the two surfaces face each other, and that the second light-incident-side diffraction grating and the second light-exiting-side diffraction grating diffract incident light fluxes having the same wavelength at the same angle of diffraction.

The case where the second light exiting surface and the first light incident surface are so disposed in positions where they face each other includes a case where the second light-exiting-side diffraction grating and the first light-incident-side diffraction grating are interposed between the second light exiting surface and the first light incident surface.

According to the aspect with the configuration described above, since the second light exiting surface and the first light incident surface are so disposed in positions where they face each other, the light having exited through the second light exiting surface is allowed to be readily incident on the first light incident surface.

Further, the angle of diffraction at which a light flux incident on the second light-incident-side diffraction grating exits and the angle of diffraction at which a light flux incident on the second light-exiting-side diffraction grating exits are equal to each other when the wavelengths of the light fluxes are the same. As a result, the angle of incidence of the light flux incident on the second light-incident-side diffraction grating and the exit angle of the light flux that exits out of the second light-exiting-side diffraction grating can be equal to each other, as in the relationship between the first light-incident-side diffraction grating and the first light-exiting-side diffraction grating described above. Therefore, the traveling direction of the light incident from the second light guide on the first light guide can be readily known, whereby the light is allowed to be reliably incident from the second light guide on the first light guide.

In the aspect described above, it is preferable that the virtual image display apparatus further includes a direction adjustment layer that is disposed in correspondence with the first light exiting surface and adjusts the traveling direction of the light that exits out of the first light guide.

As the direction adjustment layer, a layer having a plurality of prisms formed therein can be exemplified. The direction adjustment layer may, for example, be located on the light exiting side of the first light-exiting-side diffraction grating described above in the case where the first light-exiting-side diffraction grating is disposed in a position where it faces the first light exiting surface, and the direction adjustment layer may instead, for example, be located on the light exiting side of the first light exiting surface in the case where the first light-exiting-side diffraction grating described above is disposed in a position where it faces the surface of the first light guide on the side opposite the first light exiting surface.

Since the exit angle of the light from the first light-exiting-side diffraction grating depends on the characteristics of the first light-exiting-side diffraction grating, a light ray that forms the center of the display light flux (hereinafter referred to as central light) does not exit along a normal to the first light exiting surface in some cases.

For example, when the first light-exiting-side diffraction grating and the first light-incident-side diffraction grating are formed of the same type of diffraction grating (diffraction gratings having the same characteristics), and the display light flux is incident on the light incident surface of the first light-incident-side diffraction grating along a normal to the light incident surface in order to cause the central light described above to exit along a normal to the first light exiting surface, part of the display light flux traveling in the first light guide via the first light-incident-side diffraction grating possibly does not travel in the first direction. The display light flux therefore needs to be incident on the light incident surface of the first light-incident-side diffraction grating in such a way that the central axis of the display light flux is inclined to the light incident surface. In this case, however, the central light described above that exits out of the first light guide via the first light-exiting-side diffraction grating is undesirably inclined to the light exiting surface of the first light-exiting-side diffraction grating when the central light exits through the light exiting surface, and the central light does not therefore exit along a normal to the first light exiting surface described above.

When the central light described above does not travel along a normal to the first light exiting surface as described above, the viewer needs to incline the sight direction with respect to the first light exiting surface, resulting in an uncomfortable image observation attitude.

In contrast, providing the direction adjustment layer described above allows adjustment of the traveling direction of the light that passes through the direction adjustment layer. For example, the traveling directions of all light rays that pass through the direction adjustment layer can therefore be so adjusted by the direction adjustment layer that the central light described above exits along a normal to the first light exiting surface. An image produced by the virtual image display apparatus and visually recognized in the form of a virtual image (image formed by display light flux) can therefore be readily viewed.

In the aspect described above, it is preferable that the first light-exiting-side diffraction grating has a characteristic in which diffraction efficiency thereof increases in the first direction.

The diffraction efficiency is a value representing how much energy can be extracted in the form of diffracted light from the energy of incident light and represents the ratio of the amount of exit light to the amount of incident light. Therefore, the diffraction efficiency represents the ratio of the amount of transmitted light to the amount of incident light in a case where the diffraction grating is a transmissive diffraction grating, and the diffraction efficiency represents the ratio of the amount of reflected light to the amount of incident light in a case where the diffraction grating is a reflective diffraction grating.

The light incident on the first light guide travels in the first direction while repeatedly undergoing internal reflection, and part of the light exits out of the virtual image display apparatus via the first light-exiting-side diffraction grating and the first light exiting surface, as described above. That is, the light that exits out of the virtual image display apparatus is attenuated by a fixed proportion as the light exiting position shifts in the first direction. Accordingly, the amount of light that exits out of the virtual image display apparatus decreases in the first direction. The luminance of an image visually recognized by the viewer therefore decreases as the position of the viewer shifts in the first direction.

In contrast, the first light-exiting-side diffraction grating having the characteristic described above can make the amount of light that exits out of the virtual image display apparatus uniform in the first direction. Images having roughly the same luminance can therefore be visually recognized in different positions in the first direction.

In the aspect described above, it is preferable that the virtual image display apparatus further includes a transmitted light level adjustment layer that is disposed on at least one of the light incident side and the light exiting side of the first light-exiting-side diffraction grating and has one of a characteristic in which transmittance at which the transmitted light level adjustment layer transmits light incident thereon increases in the first direction and a characteristic in which reflectance at which the transmitted light level adjustment layer reflects the light decreases in the first direction.

According to the aspect with the configuration described above, since the amount of light that exits out of the virtual image display apparatus can be made uniform in the first direction, as in the case where the first light-exiting-side diffraction grating itself has one of the characteristics described above, images having roughly the same luminance can be visually recognized in different positions in the first direction.

In the aspect described above, it is preferable that the display light flux contains at least one type of color light having a wavelength width of 10 nm or wider.

The color light can, for example, be classified into red, green, or blue. The color light having the wavelength width of 10 nm or wider may have a continuous range of wavelength or may have non-continuous ranges as long as the color light can be classified into a single color.

When the display light flux containing color light having a relatively narrow wavelength width enters the first-incident-side diffraction grating, light rays that form the color light are diffracted by the first light-incident-side diffraction grating at roughly the same diffraction angle, and the diffracted light rays travel in the first light guide. The color light rays traveling in the first light guide in the first direction travel along roughly the same optical path and exit out of the virtual image display apparatus via the first light exiting surface and the first light-exiting-side diffraction grating through positions set apart at roughly equal intervals in the first direction. In this case, the positions where the light rays exit out of the virtual image display apparatus are not so dispersed, possibly resulting in the change in luminance that occurs when a light guide having the plurality of semi-transparent layers described above is employed.

In contrast, since the color light has a wavelength width of 10 nm or wider, light rays classified into the same color but having different wavelengths are incident on the first light-incident-side diffraction grating, their optical paths in the first light guide can be made different from each other, whereby the positions where light rays that form the light classified into the color exits can be reliably dispersed, and the change in luminance described above can be reliably avoided.

### BRIEF DESCRIPTION OF THE DRAWINGS

The invention will be described with reference to the accompanying drawings, wherein like numbers reference like elements.

FIG. 1 is a perspective view showing a schematic configuration of a virtual image display apparatus according to a first embodiment of the invention.

FIG. 2 is a lateral cross-sectional view showing the virtual image display apparatus according to the first embodiment.

FIG. 3 is a longitudinal cross-sectional view showing the virtual image display apparatus according to the first embodiment.

FIG. 4 is a diagrammatic view showing the optical path of light incident on a light-incident-side light guide apparatus in the first embodiment.

FIG. 5 is a diagrammatic view showing the optical paths of first to third color light rays incident on the light-incident-side light guide apparatus in the first embodiment.

FIG. 6 is a diagrammatic view showing the optical path of a light ray incident on a light-exiting-side light guide apparatus in the first embodiment.

FIG. 7 is another diagrammatic view showing the optical path of the light ray incident on the light-exiting-side light guide apparatus in the first embodiment.

FIG. 8 is a block diagram showing the configuration of a projection apparatus in the first embodiment.

FIG. 9 is a lateral cross-sectional view showing a variation of the virtual image display apparatus in the first embodiment.

FIG. 10 is a longitudinal cross-sectional view showing the variation of the virtual image display apparatus in the first embodiment.

FIG. 11 is a diagrammatic view showing the configuration of a virtual image display apparatus according to a second embodiment of the invention and the optical paths of light rays outputted from the virtual image display apparatus.

FIG. 12 is a perspective view showing a schematic configuration of a virtual image display apparatus according to a third embodiment of the invention.

FIG. 13 is a diagrammatic view showing the configuration of a virtual image display apparatus according to a fourth embodiment of the invention and the optical paths of light rays outputted from the virtual image display apparatus.

FIG. 14 is a diagrammatic view showing the configuration of a light-incident-side light guide apparatus in the fourth embodiment and the optical path of a light ray that passes through the light-incident-side light guide apparatus.

### DESCRIPTION OF EXEMPLARY EMBODIMENTS

### First Embodiment

A first embodiment of the invention will be described below with reference to the drawings.

### Schematic Configuration of Virtual Image Display Apparatus

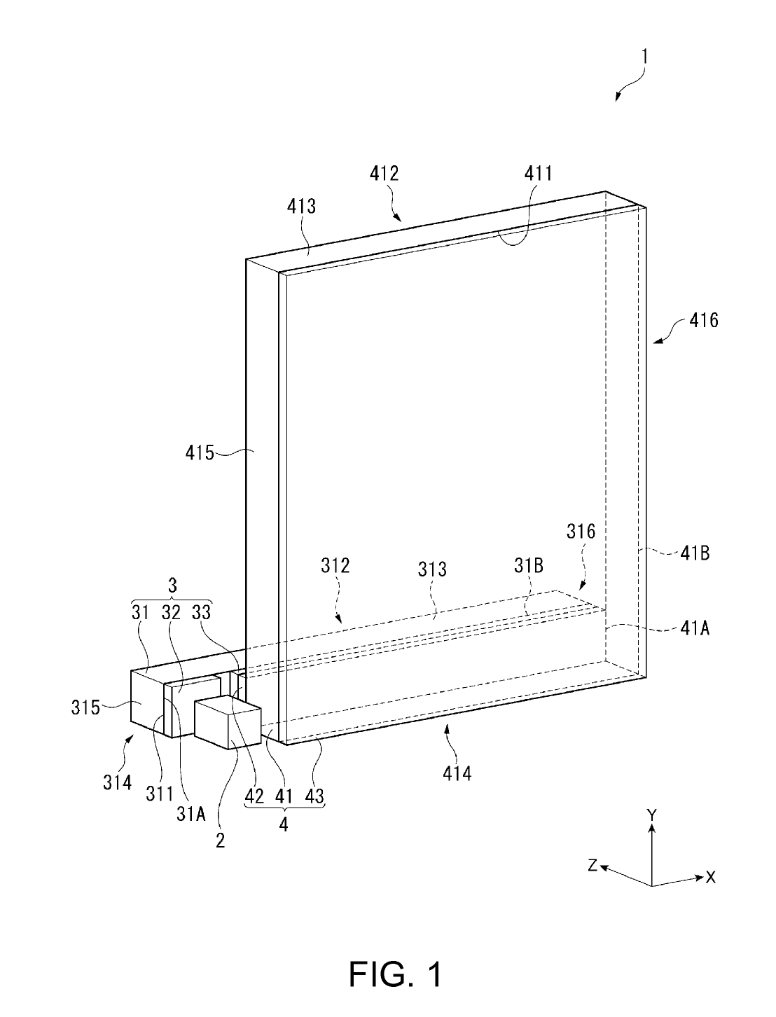

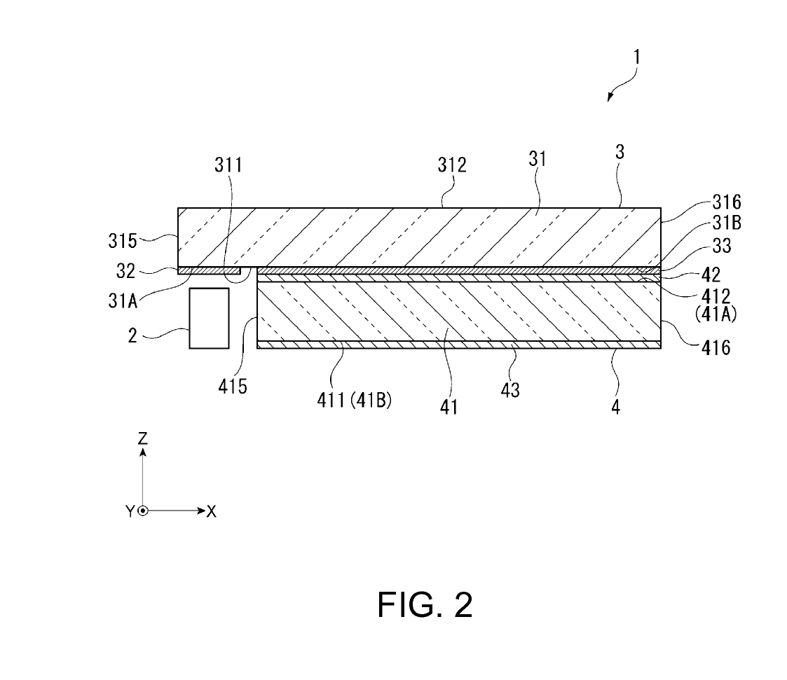

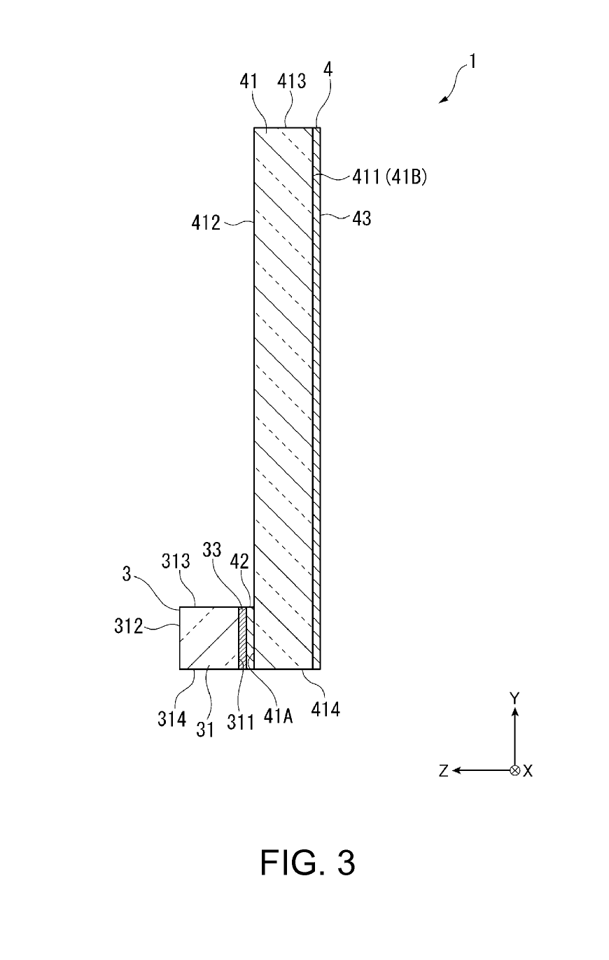

FIG. 1 is a perspective view showing a schematic configuration of a virtual image display apparatus 1 according to the present embodiment. FIGS. 2 and 3 are lateral and longitudinal cross-sectional views, respectively, showing the virtual image display apparatus 1. In FIG. 3, a projection apparatus 2 is not shown.

The virtual image display apparatus 1 according to the present embodiment includes a projection apparatus 2, which projects a display light flux that forms an image, a light-incident-side light guide apparatus 3, on which the display light flux is incident, and a light-exiting-side light guide apparatus 4, which is disposed in a position where it partially faces the light-incident-side light guide apparatus 3 and which disperses the display light flux incident from the light-incident-side light guide apparatus 3 and allows the dispersed display light flux to exit, as shown in FIGS. 1 to 3.

In the virtual image display apparatus 1, the display light flux projected from the projection apparatus 2 is incident on the light-incident-side light guide apparatus 3. The display light flux having been incident on the light-incident-side light guide apparatus 3 travels in the longitudinal direction of the light-incident-side light guide apparatus 3 (an X direction, which will be described later, and the second direction in the aspect of the invention) while repeatedly undergoing internal reflection and reaches a light exiting surface 31B, which is an interface with the outside. Part of the display light flux having reached the light exiting surface 31B undergoes internal reflection at the light exiting surface 31B and further travels in the longitudinal direction described above, whereas the other part of the display light flux exits to the outside and is incident on the light-exiting-side light guide apparatus 4, which faces the light exiting surface 31B. The light having been incident on the light-exiting-side light guide apparatus 4 travels in the light-exiting-side light guide apparatus 4 in a direction orthogonal to the longitudinal direction described above (a Y direction, which will be described later, and the first direction in the aspect of the invention) while undergoing internal reflection and reaches a light exiting surface 41B, which forms an interface with the outside. Part of the light having reached the light exiting surface 41B undergoes internal reflection at the light exiting surface 41B and further travels in the orthogonal direction described above, whereas the other part of the light exits to the outside and is visually recognized as an image. The image is visually recognized as a virtual image as if it were located on the far side of the light-exiting-side light guide apparatus 4.

Each of the light-incident-side light guide apparatus 3 and the light-exiting-side light guide apparatus 4 includes a light guide and diffraction gratings disposed on the light incident side and the light exiting side of the light guide. Although will be described later in detail, each of the diffraction gratings separates light that forms the light display light flux incident thereon into light rays diffracted at diffraction angles according to the angle of incidence of the light and the wavelengths of the light and allows the separated light fluxes to exit. The configuration described above prevents the luminance change observed in a light guide that sequentially separates part of internally traveling light through reflection at a plurality of semi-transparent layers and allows the separated light to exit, and the configuration therefore prevents degradation in an image visually recognized as a virtual image.

Among the components of the thus configured virtual image display apparatus 1, the projection apparatus 2 will be described later in detail.

In the following description and drawings, X, Y, and Z directions are directions orthogonal to each other. In the present embodiment, it is assumed that the Z direction is a direction along a horizontal direction, that the X direction is a direction along the horizontal direction and oriented from left to right when viewed from the side opposite the Z-direction side, and that the Y direction is a direction opposite the vertical direction (direction oriented from below to above).

### Configuration of Light-Incident-Side Light Guide Apparatus

The light-incident-side light guide apparatus 3 has a function of guiding an image incident from the projection apparatus 2 to the light-exiting-side light guide apparatus 4. The light-incident-side light guide apparatus 3 includes a light-incident-side light guide 31, a light-incident-side diffraction grating 32, and a light-exiting-side diffraction grating 33, as shown in FIGS. 1 to 3.

The light-incident-side light guide 31, which corresponds to the second light guide in the aspect of the invention, is made of glass, a resin, or any other light transmissive material and is so formed that it has a roughly rectangular columnar shape with the longitudinal axis thereof extending along the X direction. The light-incident-side light guide 31 is disposed in a position where it faces the light-exiting-side light guide apparatus 4 in such a way that part of the light-incident-side light guide 31 on the X-direction side overlaps in the Z direction with part of the light-exiting-side light guide apparatus 4.

The thus configured light-incident-side light guide 31 has a first surface 311 and a second surface 312, each of which extends along the XY plane, a third surface 313 and a fourth surface 314, each of which extends along the XZ plane, and a fifth surface 315 and a sixth surface 316, each of which extends along the YZ plane. Excluding the first surface 311, which faces the projection apparatus 2 and the light-exiting-side light guide apparatus 4, a total reflection layer is formed over each of the surfaces 312 to 316.

The first surface 311 is a surface on which the display light flux is incident from the projection apparatus and through which the light having traveled in the light-incident-side light guide 31 exits.

In detail, the first surface 311 has an area that does not overlap with the light-exiting-side light guide apparatus 4 in the Z direction and is located on the side opposite the X-direction side, and the area is set to be a light incident surface 31A (corresponding to the second light incident surface in the aspect of the invention), on which the display light flux described above is incident.

The first surface 311 further has an area that overlaps with the light-exiting-side light guide apparatus 4 in the Z direction, and the area is set to be a light exiting surface 31B (corresponding to the second light exiting surface in the aspect of the invention), through which the light having traveled in the light-incident-side light guide 31 toward the X-direction side exits.

The first surface 311 further has an area excluding the light incident surface 31A and the light exiting surface 31B, and the total reflection layer described above is formed on the area.

The light-incident-side diffraction grating 32, which corresponds to the second light-incident-side diffraction grating in the aspect of the invention, is so attached that it covers the light incident surface 31A described above. The light-incident-side diffraction grating 32 diffracts light to be incident on the light incident surface 31A in such a way that the light repeatedly undergoes internal reflection in the light-incident-side light guide 31 and travels toward the X-direction side. That is, the light-incident-side diffraction grating 32 receives the display light flux projected from the projection apparatus 2 in the Z direction, diffracts light rays that form the display light flux at angles of diffraction according to the wavelengths of the light rays, and causes the diffracted light rays to be incident on the light incident surface 31A.

The light-exiting-side diffraction grating 33, which corresponds to the second light-exiting-side diffraction grating in the aspect of the invention, is so attached that it covers the light exiting surface 31B described above. The light-exiting-side diffraction grating 33 diffracts light incident from the light-incident-side light guide 31 in such a way that the incident light travels in the direction in which the light that exits through the light exiting surface 31B travels (that is, in the direction opposite the Z direction perpendicular to the X direction). That is, the light-exiting-side diffraction grating 33 diffracts light rays incident through the light exiting surface 31B (light rays that form display light flux described above) at angles of diffraction according to the wavelengths of the light and causes the diffracted light rays to be incident on a light-incident-side diffraction grating 42 in the light-exiting-side light guide apparatus 4, which will be described later.

The light-incident-side diffraction grating 32 and the light-exiting-side diffraction grating 33 have the same characteristic in terms of diffraction of light incident thereon. Specifically, the diffraction gratings 32 and 33 are characterized in that they diffract incident light fluxes having the same wavelength at the same angle of diffraction. Therefore, for example, when light having a wavelength of 660 nm, which is classified to red light, is incident on the diffraction gratings 32 and 33, the light rays diffracted by and exiting through diffraction surfaces of the diffraction gratings travel at the same angle (angle of diffraction) with respect to the traveling direction of the light having been incident on the diffraction surfaces. The same holds true for light of the other wavelengths (at least light in visible region).

Each of the diffraction gratings 32 and 33 is a transmissive diffraction grating and may instead be formed of a hologram sheet.

### Optical Path of Image-Forming Display Light Flux Incident on Light-Incident-Side Light Guide Apparatus

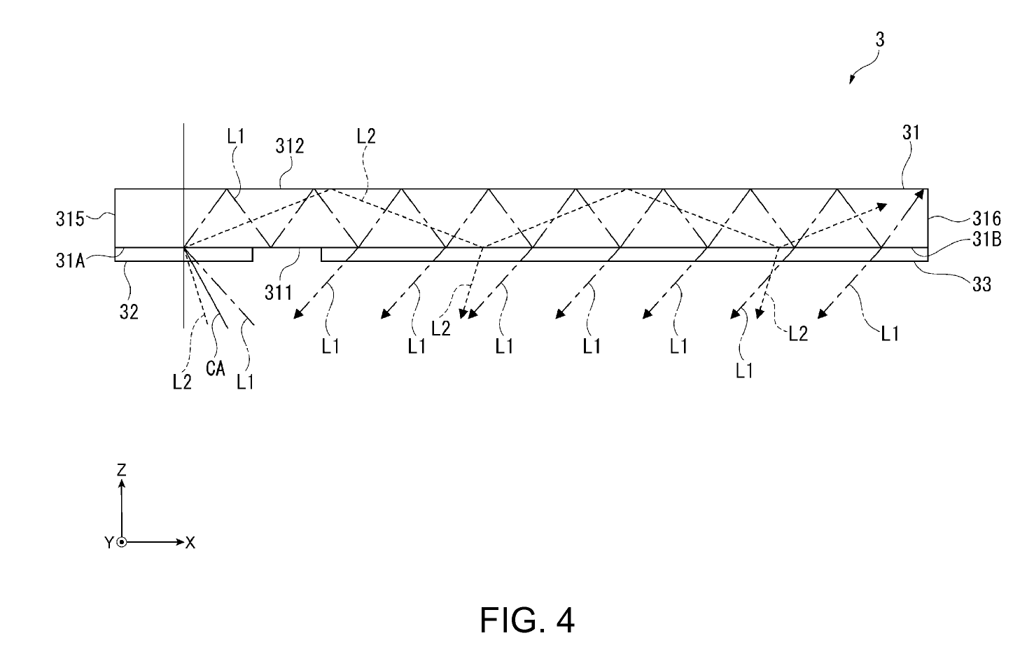

FIG. 4 is a diagrammatic view showing the optical path of the light incident on the light-incident-side light guide apparatus 3. In detail, FIG. 4 shows the optical paths of light rays that form one X-direction end and the other X-direction end of an image formed by the display light flux.

A description will now be made of the optical path of the display light flux in the light-incident-side light guide apparatus 3.

The display light flux projected from the projection apparatus 2 has a predetermined viewing angle, as shown in FIG. 4. The display light flux is projected in a direction of the central axis CA thereof inclined to the Z direction (in other words, in a direction of the central axis CA inclined to the diffraction surface of the light-incident-side diffraction grating 32) and enters the light-incident-side light guide 31 via the light-incident-side diffraction grating 32. In this process, light L1 having a predetermined wavelength and forming one X-direction end of an image formed by the display light flux (hereinafter referred to as one-end light) is diffracted at an angle of diffraction according to the characteristic of the light-incident-side diffraction grating 32 and then enters the light-incident-side light guide 31, as indicated by the dashed line shown in FIG. 4. Light L2 having the same wavelength and forming the other end of the image (hereinafter referred to as other-end light) is diffracted by the light-incident-side diffraction grating 32 at the same angle of diffraction and then enters the light-incident-side light guide 31, as indicated by the dotted line shown in FIG. 4. That is, the one-end light L1 and the other-end light L2, which are incident on the light-incident-side diffraction grating 32 at different angles of incidence, are diffracted by the light-incident-side diffraction grating 32, exit out thereof at different exit angles, and are introduced into the light-incident-side light guide 31 through the light incident surface 31A.

The one-end light L2 described above having been introduced into the light-incident-side light guide 31 travels toward the X-direction side while repeatedly undergoing internal reflection at the interfaces (surfaces 311 to 316) on each of which the total reflection layer is formed. Part of the one-end light (predetermined proportion of the light) having reached multiple areas of the light exiting surface 31B passes through the light exiting surface 31B, is incident on the light-exiting-side diffraction grating 33, is diffracted at an angle of diffraction according to the characteristic of the light-exiting-side diffraction grating 33, and exits out thereof. On the other hand, the other part of the one-end light undergoes internal reflection at the light exiting surface 31B, travels toward the X-direction side again, undergoes internal reflection at the interfaces described above, and is then incident on the light exiting surface 31B again. Part of the other part of the one-end light exits to the outside through the light exiting surface 31B and the light-exiting-side diffraction grating 33, and the remaining light undergoes internal reflection at the light exiting surface 31B. As described above, whenever the one-end light L1 described above that travels in the light-incident-side light guide 31 toward the X-direction side while undergoing internal reflection is incident on the light exiting surface 31B, part of the one-end light L1 exits to the outside.

The other-end light L2 described above, which is introduced into the light-incident-side light guide 31 through the light incident surface 31A, on which the other-end light L2 is obliquely incident, also travels toward the X-direction side while undergoing internal reflection. Part of the other-end light L2 (predetermined proportion of the light) having been incident on the light exiting surface 31B passes through the light exiting surface 31B, is incident on the light-exiting-side diffraction grating 33, is diffracted at an angle of diffraction according to the characteristic of the light-exiting-side diffraction grating 33, and exits out thereof. On the other hand, the other part of the other-end light undergoes internal reflection at the light exiting surface 31B, travels toward the X-direction side again, further undergoes internal reflection at the interfaces described above, and is then incident on the light exiting surface 31B again. As described above, whenever the other-end light L2 that travels in the light-incident-side light guide 31 toward the X-direction side while undergoing internal reflection is incident on the light exiting surface 31B, part of the other-end light L2 exits to the outside, as in the case of the one-end light L1 described above.

The light rays described above reach a viewer, and the viewer views an image having the predetermined viewing angle described above.

### Optical Paths of Multi-Wavelength Light Incident on Light-Incident-Side Light Guide Apparatus

A diffraction grating has a function of diffracting light incident thereon at an angle of diffraction that varies in accordance with the wavelength of the light and outputting the diffracted light. The longer the wavelength, the greater the angle of diffraction.

The multi-wavelength light that forms the display light flux incident on the light-incident-side diffraction grating 32 is therefore caused to exit out of the light-incident-side diffraction grating 32 at different angles and enter the light-incident-side light guide 31.

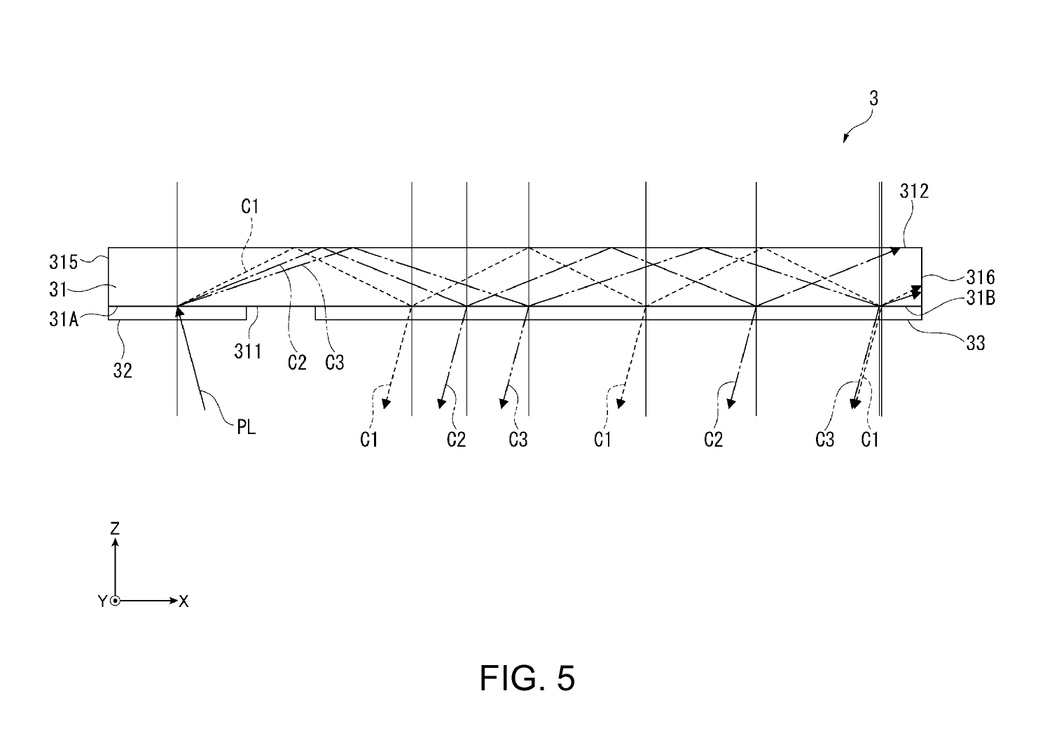

FIG. 5 is a diagrammatic view showing the optical paths of first color light C1, second color light C2, and third color light C3, which form a display light flux PL incident on the light-incident-side light guide apparatus 3 and have wavelengths different from one another.

For example, when the first color light C1 (dotted line), the second color light C2 (dashed line), and the third color light C3 (chain double-dashed line), which are classified into the same color but have different wavelengths, are incident on the light-incident-side diffraction grating 32, the color light rays C1 to C3 are diffracted at different angles of diffraction and therefore incident on the light-incident-side light guide 31 at different angles of incidence, as shown in FIG. 5.

When the color light rays C1 to C3 travel in the light-incident-side light guide 31 toward the X-direction side while undergoing internal reflection and part of the color light rays C1 to C3 exits through the light exiting surface 31B and is incident on the light-exiting-side diffraction grating 33, the light rays are diffracted at angles of diffraction according to their wavelengths and exit out of the light-exiting-side diffraction grating 33. In this process, since the light-incident-side diffraction grating 32 and the light-exiting-side diffraction grating 33 are characterized in that they diffract light fluxes having the same wavelength at the same angle of diffraction, the first color light C1, the second color light C2, and the third color light C3 exit out of the light-exiting-side diffraction grating 33 at the same angle.

As described above, since in accordance with the wavelength of the incident light, the exit angle of the light that exits out of the light-incident-side diffraction grating 32 and hence the angle of incidence of the light that is incident on the light-incident-side light guide 31 varies, the optical path of the multi-wavelength light varies, and the multi-wavelength light exits through the light exiting surface 31B in different positions although it exits out of the light-exiting-side diffraction grating 33 at the same exit angle.

For example, in a configuration in which the display light flux is incident on a light guide in which a plurality of semi-transparent layers inclined to the central axis of the display light flux are formed and reflected off the semi-transparent layers and part of the display light flux exits out of the light guide, the presence of the semi-transparent layers is undesirably visually recognized because the luminance of the exiting light changes. Further, when the light accompanied by the change in luminance is superimposed on an image visually recognized as a virtual image, a degraded image is visually recognized.

In contrast, the color light rays C1 to C3 described above, which are light rays classified into the same color, travel in the light-incident-side light guide 31 toward the X-side direction and exit out of the light-exiting-side diffraction grating 33 through different positions according to the wavelengths of the light rays. That is, as long as the display light flux contains color light having a predetermined width of wavelength that is classified into a plurality of colors, the light rays contained in the display light flux exit out of the light-exiting-side diffraction grating 33 through different positions. As a result, the light is allowed to exit out of the light-exiting-side diffraction grating 33 in a dispersed manner. The situation in which the structure in the light-incident-side light guide 31 is visually recognized can thus be avoided, and degradation in a visually recognized image can therefore suppressed.

Although will be described later in detail, the light-exiting-side light guide apparatus 4 is configured in the same manner as the light-incident-side light guide apparatus 3. To this end, the projection apparatus 2 projects the display light flux formed of a plurality of color light rays that cover a relatively wide wavelength width to the light-incident-side light guide apparatus 3 described above. The configuration of the projection apparatus 2 will be described later in detail.

### Configuration of Light-Exiting-Side Light Guide Apparatus

The light-exiting-side light guide apparatus 4 has a function of dispersing the display light flux incident from the light-incident-side light guide apparatus 3 and causing the dispersed display light flux to exit out of the light-exiting-side light guide apparatus 4 in the direction opposite the Z direction for visual recognition of an image formed by the display light flux in the form of a virtual image. The thus functioning light-exiting-side light guide apparatus 4 has the same configuration as that of the light-incident-side light guide apparatus 3 and specifically includes a light-exiting-side light guide 41, a light-incident-side diffraction grating 42, and a light-exiting-side diffraction grating 43, as shown in FIGS. 1 to 3.

The light-exiting-side light guide 41, which corresponds to the first light guide in the aspect of the invention, is made of glass, a resin, or any other light transmissive material and has a roughly rectangular plate-like shape. The light-exiting-side light guide 41 is so disposed along the XY plane that an end portion of the light-exiting-side light guide 41 on the side opposite the Y-direction side overlaps in the Z direction with the light-exiting-side diffraction grating 33, which covers the light exiting surface 31B. Further, the dimension of the light-exiting-side light guide 41 in the Y direction is greater than the dimension of the light-exiting-side diffraction grating 33 in the Y direction.

The thus configured light-exiting-side light guide 41 has a first surface 411 and a second surface 412, each of which extends along the XY plane, a third surface 413 and a fourth surface 414, each of which extends along the XZ plane, and a fifth surface 415 and a sixth surface 416, each of which extends along the YZ plane. Excluding the first surface 411 and the second surface 412, a total reflection layer is formed over each of the surfaces 413 to 416.

The second surface 412 has an area that overlaps with the light-incident-side light guide apparatus 3 in the Z direction, and the area is set to be a light incident surface 41A (corresponding to the first light incident surface in the aspect of the invention), on which the display light flux that exited from the light-incident-side light guide apparatus 3 is incident. The dimension of the light incident surface 41A in the X direction is roughly equal to the dimension of the light-exiting-side diffraction grating 33 in the X direction so that the entire display light flux that exited from the light-incident-side light guide apparatus 3 is incident on the light incident surface 41A. The total reflection layer is formed on the second surface 412 in the area excluding the light incident surface 41A.

A roughly entire surface of the first surface 411 is set to be a light exiting surface 41B (corresponding to the first light exiting surface in the aspect of the invention), through which the light having traveled in the light-exiting-side light guide 41 exits.

The thus configured light-exiting-side light guide 41, although will be described later in detail, causes the display light flux incident through the light incident surface 41A to travel in the Y direction, which is the direction away from the light incident surface 41A, while causing the display light flux to undergo internal reflection at interfaces with the outside (primarily first surface 411 and second surface 412). In this process, part of the light incident on multiple areas of the light exiting surface 41B exits through the light exiting surface 41B to the outside, and the remaining light undergoes internal reflection at the light exiting surface 41B and further travels toward the Y-direction side.

The light-incident-side diffraction grating 42, which corresponds to the first light-incident-side diffraction grating in the aspect of the invention, is so attached to the light incident surface 41A that the light-incident-side diffraction grating 42 covers the light incident surface 41A described above. The light-incident-side diffraction grating 42 diffracts light incident through the light incident surface 41A in such a way that the light repeatedly undergoes internal reflection in the light-exiting-side light guide 41 and travels toward the Y-direction side. That is, the light-incident-side diffraction grating 42 receives light rays contained in the display light flux incident from the light-exiting-side diffraction grating 33 described above, diffracts the light rays at angles of diffraction according to the wavelengths of the light rays, and causes the diffracted light rays to be incident on the light incident surface 41A.

The light-exiting-side diffraction grating 43, which corresponds to the first light-exiting-side diffraction grating in the aspect of the invention, is so attached to the light exiting surface 41B described above that the light-exiting-side diffraction grating 43 covers the light exiting surface 41B. The light-exiting-side diffraction grating 43 diffracts the light incident from the light-exiting-side light guide 41 in such a way that the incident light travels in the direction in which the light that exits through the light exiting surface 41B travels (that is, in the direction opposite the Z direction perpendicular to the Y direction). That is, the light-exiting-side diffraction grating 43 diffracts the light having exited through the light exiting surface 41B at angles of diffraction according to the wavelengths of the light and causes the diffracted light rays to exit to the outside.

The light-incident-side diffraction grating 42 and the light-exiting-side diffraction grating 43 have the same characteristic in terms of diffraction of light incident thereon, as the diffraction gratins 32 and 33. Therefore, the light having entered the light-exiting-side light guide 41 via the light-incident-side diffraction grating 42 is incident on the light-exiting-side diffraction grating 43 through the light exiting surface 41B of the light-exiting-side light guide 41 and exits out of the light-exiting-side diffraction grating 43 at an exit angle equal to the angle of incidence of the light having been incident on the light-incident-side diffraction grating 42.

Each of the diffraction gratings 42 and 43 is a transmissive diffraction grating and may instead be formed of a hologram sheet, as in the case of the diffraction gratings 32 and 33 described above.

### Optical Path of Light Incident on Light-Exiting-Side Light Guide Apparatus

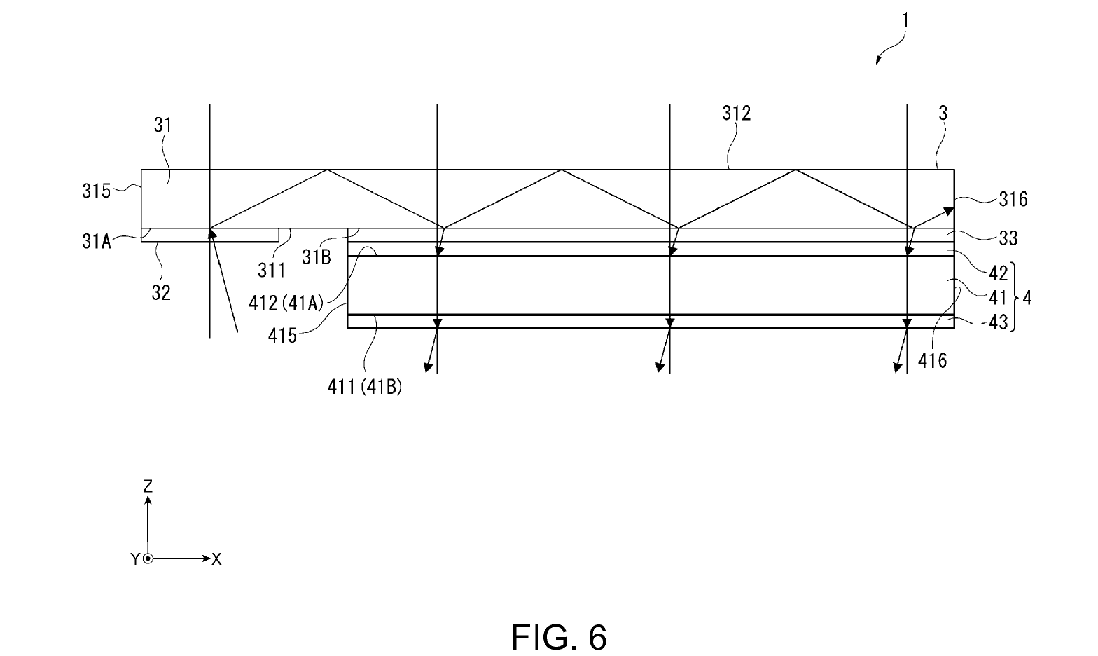

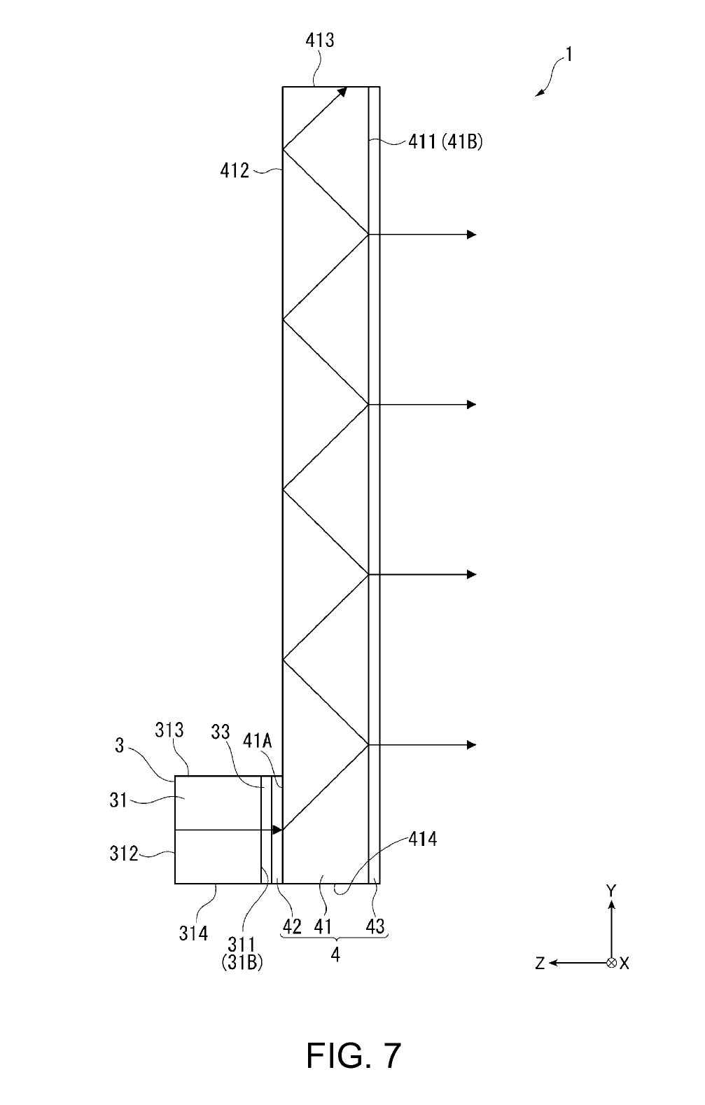

FIGS. 6 and 7 are diagrammatic views showing the optical path of the light incident on the light-exiting-side light guide apparatus 4. Among the light rays that form the display light flux described above incident on the light-exiting-side light guide apparatus 4, FIGS. 6 and 7 show the optical path of a light ray having a predetermined wavelength and incident on the light-incident-side light guide apparatus 3 along the central axis of the display light flux projected from the projection apparatus 2 and then incident from the light-incident-side light guide apparatus 3 on the light-exiting-side light guide apparatus 4.

The light rays that form the display light flux described above are incident on the light-incident-side diffraction grating 42 through a roughly entire surface of the light-exiting-side diffraction grating 33 described above. Specifically, even when only a light flux that has a predetermined wavelength and forms a predetermined portion of the display light flux is considered, the light ray having the predetermined wavelength is incident on the light-incident-side diffraction grating 42 through a plurality of portions of the light-exiting-side diffraction grating 33 that are located along the X direction, as shown in FIG. 6. The light-incident-side diffraction grating 42 then diffracts each of the incident light rays at an angle of diffraction according to the characteristic of the light-incident-side diffraction grating 42 and the wavelength of the light ray and causes the diffracted light ray to enter the light-exiting-side light guide 41 through the light incident surface 41A. The light-incident-side diffraction grating 42 is so set that it guides the incident light ray in such a way that it travels toward the Y-direction side. The light ray introduced into the light-exiting-side light guide 41 therefore travels not only toward the side opposite the Z-direction side but also toward the Y-direction side and reaches multiple areas of the light exiting surface 41B, as shown in FIG. 7.

Part of the light rays (predetermined proportion of the light) having reached the light exiting surface 41B exits through the light exiting surface 41B to the outside, as in the case described above, and is incident on the light-exiting-side diffraction grating 43, which is disposed on the light exiting surface 41B. The other part of the light rays undergoes internal reflection at the light exiting surface 41B and further travels toward the Z-direction side and the Y-direction side. The light rays undergo internal reflection at the other interfaces and are incident on the light exiting surface 41B again, and part of the light ray further exits to the outside. As described above, the light introduced into the light-exiting-side light guide 41 travels toward the Y-direction side while repeatedly undergoing internal reflection.

The light incident on the light-exiting-side diffraction grating 43 is diffracted at an angle of diffraction according to the angle of incidence of the light having been incident on the light-exiting-side diffraction grating 43 and the wavelength of the light and exits out of the light-exiting-side light guide apparatus 4 in the direction opposite the Z direction.

Since the light-exiting-side diffraction grating 43 and the light-incident-side diffraction grating 42 have the same characteristic, the light-exiting-side diffraction grating 43 allows the light incident thereon to exit at an exit angle equal to the angle of incidence of the light having been incident on the light-incident-side diffraction grating 42. Therefore, when light is obliquely incident on the diffraction surface of the light-incident-side diffraction grating 42, the light exits out of the light-exiting-side diffraction grating 43 in a direction that is oblique by the same amount. As a result, a viewer in any position on the opposite side of the light-exiting-side diffraction grating 43 to the Z-direction side but within the range over which the light is incident visually recognizes an image formed by the exiting light, that is, an image projected by the projection apparatus 2 onto the light-incident-side diffraction grating 32 in the form of a virtual image as if it were located on the Z-direction side of the light-exiting-side light guide apparatus 4.

### Configuration of Projection Apparatus

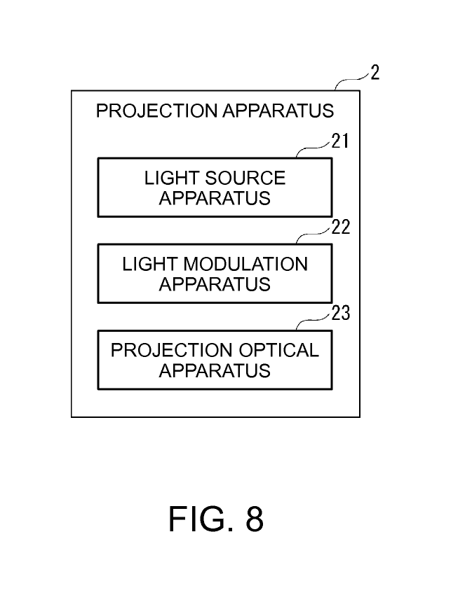

FIG. 8 is a block diagram showing the configuration of the projection apparatus 2.

The projection apparatus 2 forms and projects an image according to image information. The projection apparatus 2 includes a light source apparatus 21, a light modulation apparatus 22, and a projection optical apparatus 23, as shown in FIG. 8.

Among them, the light modulation apparatus 22 modulates light that exited from the light source apparatus 21 to form an image according to the image information. As the light modulation apparatus 22, at least one of a transmissive and reflective liquid crystal panels can be employed, or a device using a micromirror device (DMD (digital micromirror device), for example) can be employed.

The projection optical apparatus 23 projects the image formed by the light modulation apparatus 22 in the form of a display light flux. In this process, the projection optical apparatus 23 emits the display light flux in such a way that the display light flux is concentrated roughly at the center of the light-incident-side diffraction grating 32 described above.

The light source apparatus 21 emits light to the light modulation apparatus 22 described above. Each of the diffraction gratings 32, 33, 42, and 43 described above separates multi-wavelength light contained in the display light flux incident on the diffraction grating and allows the separated light fluxes to exit at angles of diffraction according to the wavelengths of the light. To this end, the light source apparatus 21 emits color light having a predetermined wavelength width and allows the light modulation apparatus to form an image containing the color light.

Specifically, the light source apparatus 21 emits light containing color light fluxes classified into red, green, and blue, and each of the color light fluxes is formed of light having a predetermined wavelength width (wavelength width of 10 nm or greater, for example). The wavelength width may be a continuous width or non-continuous widths. Configuring the light source apparatus 21 to emit the light described above prevents the change in luminance described above from occurring.

As the light source apparatus 21 that emits the light described above, a configuration having an ultrahigh-pressure mercury lamp or any other discharge light source lamp or a configuration having an LED (light emitting diode) can be employed by way of example.

### Advantageous Effects Provided by First Embodiment

According to the virtual image display apparatus 1 according to the present embodiment described above, the following advantageous effects are provided.

The light-incident-side diffraction grating 42, which is located on the light incident side of the light incident surface 41A, diffracts light rays that form the incident display light flux at different angles of diffraction according to the wavelengths of the light rays in such a way that the light rays repeatedly undergo internal reflection in the light-exiting-side light guide 41 and travel toward the X-direction side. The light rays having the different wavelengths thus travel in the Y direction, which is the direction away from the light incident surface 41A, while repeatedly undergoing internal reflection at different areas and are incident on different areas of the light exiting surface 41B. The light rays having exited out of the different positions of the light exiting surface 41B pass the light-exiting-side diffraction grating 43, where the light rays are diffracted again at angles of diffraction according to the wavelengths. An image formed by the incident light can therefore be visually recognized in an arbitrary position present in the Y direction and facing the light-exiting-side diffraction grating 43 on the Z-direction in the form of a virtual image as if it were located on the Z-direction side of the light-exiting-side light guide 41.

The angle of incidence of a light ray that enters the light-exiting-side light guide 41 after diffracted by the light-incident-side diffraction grating 42 varies in accordance with the wavelength of the light ray. Therefore, since the light rays of the different wavelength travel along different optical paths in the light-exiting-side light guide 41, whereby the light rays are allowed to exit through different positions along the light exiting surface 41B in a dispersed manner.

Further, the angle of incidence of a light ray incident via the light-incident-side diffraction grating 42 varies in accordance with the position of the light ray in the display light flux, as shown in FIG. 4. The light rays that form the display light flux are thus allowed to travel along different optical paths in the light-exiting-side light guide 41 in accordance with the positions of the light rays. As a result, the light rays are allowed to be incident on the light exiting surface 41B in different positions and are eventually allowed to exit via the light exiting surface 41B and the light-exiting-side diffraction grating 43 in a dispersed manner. Further, since the light rays having exited through the light exiting surface 41B exit to the outside via the light-exiting-side diffraction grating 43, the exit angles of the light rays through the light exiting surface 41B can be adjusted on the wavelength basis.

The thus configured virtual image display apparatus 1 can prevent a change in luminance that occurs in a case where the display light flux is caused to be incident on a light guide in which a plurality of semi-transparent layers inclined to the Y direction are formed and the light reflected off the semi-transparent layers is caused to exit, whereby a situation in which the change in luminance is visually recognized and an image formed by the exiting light is degraded can be avoided.

The light-incident-side diffraction grating 42 and the light-exiting-side diffraction grating 43 have the same characteristic in terms of diffraction of light incident thereon. The angle of diffraction of light diffracted by the light-incident-side diffraction grating 42 and the angle of diffraction of light diffracted by the light-exiting-side diffraction grating 43 are equal to each other for each wavelength of the incident light. As a result, the angle of incidence of light incident on the light-incident-side diffraction grating 42 is allowed to be equal to the exit angle of the light that exits out of the light-exiting-side diffraction grating 43, whereby the exit angle of light that exits out of the virtual image display apparatus 1 can be readily adjusted, and the viewer is allowed to readily visually recognize an image formed by the light.

The light-incident-side light guide 31 not only causes light having entered it to repeatedly undergo internal reflection and travel toward the X-direction side but also causes part of the light to exit to the outside when the light undergoes internal reflection at the light exiting surface 31B, which is an interface with the outside and causes the light having exited through the light exiting surface 31B to be incident on the light-exiting-side light guide apparatus 4 described above. Since the light-incident-side light guide 31 is elongated in the X direction, and the light-exiting-side light guide 41 is elongated in the X and Y directions, light rays that form the display light flux are dispersed in the X direction by the light-incident-side light guide apparatus 3 and dispersed in the Y direction by the light-exiting-side light guide apparatus 4, and the thus dispersed light rays are then allowed to exit. The range over which an image formed by the display light flux can be visually recognized can therefore be widened in the X and Y directions.

The light-incident-side light guide apparatus 3 includes the light-incident-side diffraction grating 32 and the light-exiting-side diffraction grating 33 as well as the light-incident-side light guide 31 described above. Therefore, when the display light flux is allowed to enter the light-incident-side light guide 31 via the light-incident-side diffraction grating 32, light rays contained in the display light flux are allowed to travel along different optical paths in the light-incident-side light guide in accordance with the wavelengths and the angles of incidence of the light rays. As a result, the light rays are allowed to be incident on the light-exiting-side diffraction grating 33 in different positions thereon. Since the light-exiting-side diffraction grating 33 diffracts the light rays incident thereon at different angles of diffraction on the wavelength basis and causes the diffracted light rays to exit out of the light-incident-side light guide apparatus 3, the light rays are allowed to exit out of the light-incident-side light guide apparatus 3 in a reliably dispersed manner, and the exit angles of the light rays that exit to the outside can be adjusted on the wavelength basis. The display light flux to be incident on the light-exiting-side light guide apparatus 4 is therefore allowed to exit in a reliably dispersed manner in the X direction.

Since the light exiting surface 31B and the light incident surface 41A are so disposed that they face each other, the light rays having exited out of the light-exiting-side diffraction grating 33 of the light-incident-side light guide apparatus 3 are allowed to be readily incident on the light-incident-side diffraction grating 42 of the light-exiting-side light guide apparatus 4.

Further, the angle of diffraction at which the light having been incident on the light-incident-side diffraction grating 32 exits is equal to the angle of diffraction at which the light having been incident on the light-exiting-side diffraction grating 33 exits for each of the wavelength of the light. The angle of incidence of the light incident on the light-incident-side diffraction grating 32 can therefore be equal to the exit angle of the light that exits out of the light-exiting-side diffraction grating 33, as in the relationship between the light-incident-side diffraction grating 42 and the light-exiting-side diffraction grating 43. Therefore, the traveling direction of the light to be incident from the light-incident-side light guide apparatus 3 on the light-exiting-side light guide apparatus 4 can be readily known, whereby the light is allowed to be reliably incident from the light-incident-side light guide apparatus 3 on the light-exiting-side light guide apparatus 4.

In a case where the display light flux containing color light rays each having a relatively narrow wavelength width is incident on the light-incident-side diffraction grating 32 and eventually on the light-incident-side diffraction grating 42, the color light rays are diffracted at roughly the same angle of diffraction by the two diffraction gratings and then incident on the light-incident-side light guide 31 and the light-exiting-side light guide 41. Since the light rays classified into the same color but having different wavelengths travel along roughly the same optical paths in the light guides 31 and 41, the light rays are incident on the light exiting surfaces 31B and 41B in roughly the same positions. In this case, the light rays classified into the same color undesirably exit through roughly the same positions on the light exiting surfaces 31B and 41B, the light rays are not dispersed, possibly resulting in the change in luminance in the case where the light guide having the plurality of semi-transparent layers described above is employed.

In contrast, when each of the color light rays has the predetermined wavelength width (wavelength width of 10 nm or wider), the color light rays are allowed to be incident on the light incident surfaces 31A and 41A via the light-incident-side diffraction gratings 32 and 42 at different angles of incidence. The color light rays classified into the same color but having different wavelengths are therefore allowed to travel different optical paths in the light guides 31 and 41, whereby the color light rays are allowed to be incident on different positions on the light exiting surfaces 31B and 41B. Therefore, since the color light rays are allowed to disperse through exit positions on the light exiting surfaces 31B and 41B, the change in luminance can be avoided, and degradation in a visually recognized image can eventually be avoided.

### Variation of First Embodiment

In the virtual image display apparatus 1 described above, since whenever the light rays repeatedly undergoing internal reflection and traveling reach the light exiting surfaces 31B and 41B, a predetermined proportion of the light rays exit to the outside and the remaining light rays undergo internal reflection, the amount (luminance) of light rays that exit through the light exiting surfaces 31B and 41B decreases (lowers) as the light rays travel in the light guides 31 and 41 in the light traveling direction. Specifically, the amount of light that exits out of the light-exiting-side diffraction grating 33 decreases with distance in the X direction, which is away from the light incident surface 31A, and the amount of light that exits out of the light-exiting-side diffraction grating 43 decreases with distance in the Y direction, which is away from the light incident surface 41A. As a result, the luminance of an image visually recognized not only on the X-direction side but also on the Y-direction side is lower than the luminance of an image visually recognized not only on the side opposite the X-direction side but also on the side opposite the Y-direction side.

As described above, a phenomenon in which the luminance of a viewed image varies depending on the viewing position occurs.

To avoid the phenomenon, the diffraction efficiency of the light-exiting-side diffraction gratings 33 and 43 may be configured to vary on a position basis.

For example, the light-exiting-side diffraction grating 33 may be characterized in that the diffraction efficiency thereof increases with distance in the X direction, which is the light traveling direction in the light-incident-side light guide 31. The thus configured light-exiting-side diffraction grating 33 allows the ratio of the amount of exiting light to the amount of incident light to increase with distance in the X direction. In other words, the light-exiting-side diffraction grating 33 has a characteristic in which the transmittance at which the light-exiting-side diffraction grating 33 transmits incident light increases whereas the reflectance at which it reflects the light decreases with distance in the X direction, whereby the amount of light that exits out of the light-incident-side light guide apparatus 3 (light-exiting-side diffraction grating 33) can be made roughly uniform in the X direction.

Similarly, the light-exiting-side diffraction grating 43 may be characterized in that the diffraction efficiency thereof increases with distance in the Y direction, which is the light traveling direction in the light-exiting-side light guide 41. The thus configured light-exiting-side diffraction grating 43 allows the ratio of the amount of exiting light to the amount of incident light to increase with distance in the Y direction. In other words, the light-exiting-side diffraction grating 43 has a characteristic in which the transmittance at which the light-exiting-side diffraction grating 43 transmits incident light increases whereas the reflectance at which it reflects the light decreases with distance in the Y direction, whereby the amount of light that exits out of the light-exiting-side light guide apparatus 4 (light-exiting-side diffraction grating 43) can be made roughly uniform in the Y direction.

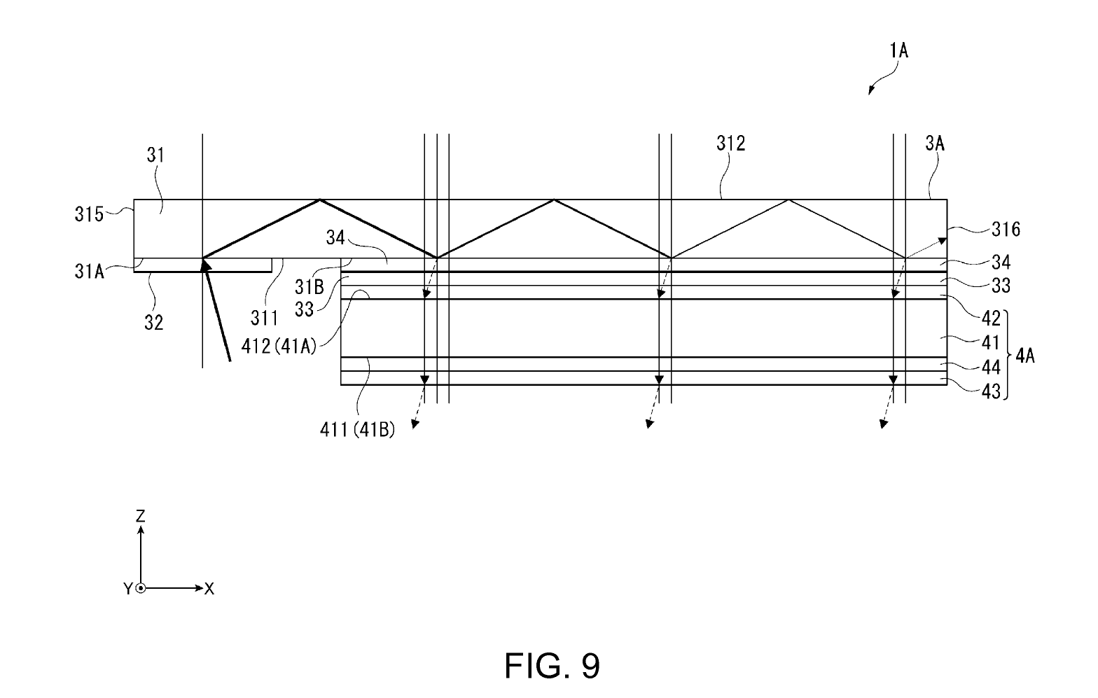

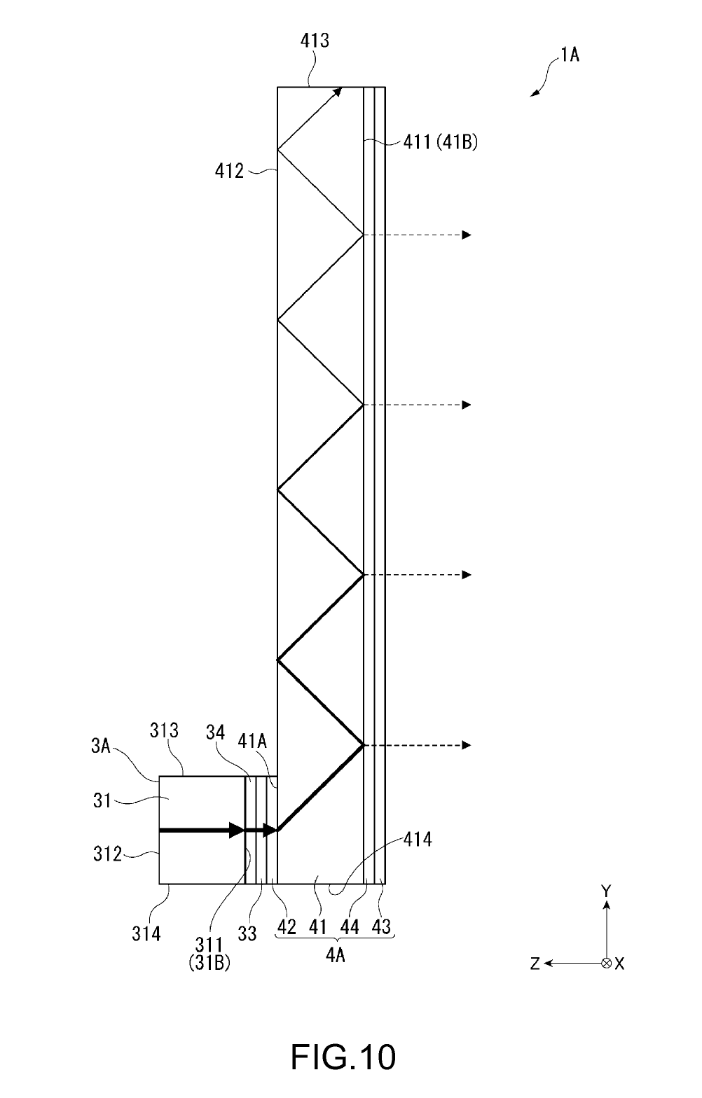

FIGS. 9 and 10 are diagrammatic views showing the configuration of a virtual image display apparatus 1A, which is a variation of the virtual image display apparatus 1 described above, and the optical path of a light ray that passes through a light-incident-side light guide apparatus 3A and a light-exiting-side light guide apparatus 4A, which form the virtual image display apparatus 1A. FIG. 9 shows the configuration of the virtual image display apparatus 1A in the XZ plane, and FIG. 10 shows the configuration of the virtual image display apparatus 1A in the YZ plane. In FIGS. 9 and 10, no projection apparatus 2 is shown.

Further, for example, transmitted light level adjustment layers 34 and 44 may be disposed between the light exiting surface 31B and the light-exiting-side diffraction grating 33 and between the light exiting surface 41B and the light-exiting-side diffraction grating 43, respectively, as illustrated in the virtual image display apparatus 1A shown in FIGS. 9 and 10.

The virtual image display apparatus 1A includes the projection apparatus 2, the light-incident-side light guide apparatus 3A, and the light-exiting-side light guide apparatus 4A, as the virtual image display apparatus 1 does. Among them, the light-incident-side light guide apparatus 3A has the same configuration and function as those of the light-incident-side light guide apparatus 3 described above except that the transmitted light level adjustment layer 34 is disposed between the light exiting surface 31B and the light-exiting-side diffraction grating 33. The light-exiting-side light guide apparatus 4A has the same configuration as that of the light-exiting-sidelight guide apparatus 4 described above except that the transmitted light level adjustment layer 44 is disposed between the light exiting surface 41B and the light-exiting-side diffraction grating 43.

The transmitted light level adjustment layer 34 has a characteristic in which the transmittance at which it transmits light incident thereon increases or the reflectance at which it reflects the light decreases with distance in the X direction, which is the light traveling direction in the light-incident-side light guide 31. The transmitted light level adjustment layer 34 allows the amounts of light rays that exit to the outside through X-direction light exiting positions on the light exiting surface 31B via the transmitted light level adjustment layer 34 and the light-exiting-side diffraction grating 33, as shown in FIG. 9, to be roughly equal to one another.

Similarly, the transmitted light level adjustment layer 44 has a characteristic in which the transmittance at which it transmits light incident thereon increases or the reflectance at which it reflects the light decreases with distance in the Y direction, which is the light traveling direction in the light-exiting-side light guide 41. The transmitted light level adjustment layer 44 allows the amounts of light rays that exit to the outside through Y-direction light exiting positions on the light exiting surface 41B via the transmitted light level adjustment layer 44 and the light-exiting-side diffraction grating 43, as shown in FIG. 10, to be roughly equal to one another.

Therefore, when the light-exiting-side diffraction gratings 33 and 43 have a characteristic in which the diffraction efficiency thereof increases in the light traveling directions in the light guides 31 and 41 or when the transmitted light level adjustment layers 34 and 44 described above are provided in the light guide apparatus 3A and 4A, the luminance values of images observed in arbitrary positions facing the light-exiting-side diffraction grating 43 can be made equal to one another.

The transmitted light level adjustment layer 34 described above may instead be disposed on the light exiting side of the light-exiting-side diffraction grating 33 or may still instead be disposed both on the light incident side and the light exiting side thereof.

Similarly, the transmitted light level adjustment layer 44 described above may instead be disposed on the light exiting side of the light-exiting-side diffraction grating 43 or may still instead be disposed both on the light incident side and the light exiting side thereof.

### Second Embodiment

A second embodiment of the invention will next be described.

A virtual image display apparatus according to the present embodiment has a direction adjustment layer as wells as the same configuration as that of the virtual image display apparatus 1 described above. The direction adjustment layer is disposed on the light exiting side of the light-exiting-side diffraction grating 43, which forms the light-exiting-side light guide apparatus 4, and adjusts the traveling direction of the light having exited out of the light-exiting-side diffraction grating 43. In this regard, the virtual image display apparatus according to the present embodiment differs from the virtual image display apparatus 1 described above. In the following description, portions that are the same or roughly the same as those having already been described have the same reference characters and will not be described.

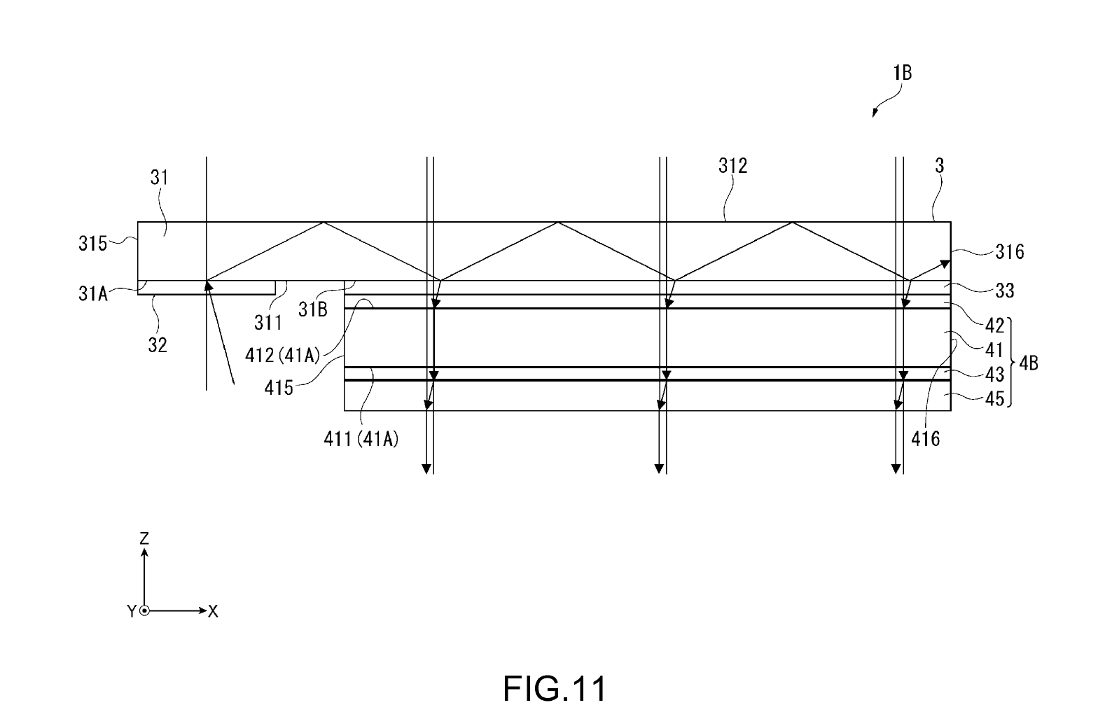

FIG. 11 is a diagrammatic view showing the configuration of a virtual image display apparatus 1B according to the present embodiment and the optical paths of light rays that exited from the virtual image display apparatus 1B. In FIG. 11, no projection apparatus 2 is shown.

The virtual image display apparatus 1B according to the present embodiment has the same configuration and function as those of the virtual image display apparatus 1 described above except that the light-exiting-side light guide apparatus 4 is replaced with a light-exiting-side light guide apparatus 4B, as shown in FIG. 11. The light-exiting-side light guide apparatus 4B further includes a direction adjustment layer 45 in addition to the configuration of the light-exiting-side light guide apparatus 4 described above.

The direction adjustment layer 45 is located on the light exiting side of the light-exiting-side diffraction grating 43 and so disposed that the direction adjustment layer 45 covers the light-exiting-side diffraction grating 43. The direction adjustment layer 45 has a function of adjusting the traveling direction of the light incident from the light-exiting-side diffraction grating 43. Specifically, the direction adjustment layer 45 adjusts the traveling directions of all light rays that pass through the direction adjustment layer 45 in such a way that a light ray that is present at the center of the display light flux projected from the projection apparatus 2 (the central light described above and light that forms the center of an image) exits along the direction of a normal to the direction adjustment layer 45 (direction of normal to light-exiting-side diffraction grating 43). The thus configured direction adjustment layer 45 can be formed of a prism sheet having a plurality of minute prisms formed therein.

### Advantageous Effects Provided by Second Embodiment

The virtual image display apparatus 1B according to the present embodiment described above can provide the following advantageous effects as well as the same advantageous effects as those provided by the virtual image display apparatus 1 described above.

Since the direction adjustment layer 45 is disposed on the light exiting side of the light-exiting-side diffraction grating 43, even when the central light ray described above having exited out of the light-exiting-side diffraction grating 43 does not travel along a normal to the light-exiting-side diffraction grating 43 (that is, normal to light exiting surface 41B), the traveling directions of the light rays that pass through the direction adjustment layer 45 can be so adjusted that the central light ray exits along a normal to the light-exiting-side diffraction grating 43 and a normal to the light exiting surface 41B. An image formed by the light that exited from the light-exiting-side light guide apparatus 4B can therefore be visually recognized without inclination of the sight direction with respect to the light-exiting-side diffraction grating 43 and the light exiting surface 41B, whereby the image can be readily visually recognized.

The light-exiting-side diffraction gratings 33 and 43 provided in the thus configured virtual image display apparatus 1B may have the characteristic shown in the variation of the first embodiment described above. Further, the virtual image display apparatus 1B may include the transmitted light level adjustment layers 34 and 44 described above. In these cases, the following advantageous effect can be provided: Images having roughly the same luminance can be visually recognized in any viewing positions.

### Third Embodiment

A third embodiment of the invention will next be described.

A virtual image display apparatus according to the present embodiment has a configuration similar to that of the virtual image display apparatus 1 described above. In the virtual image display apparatus 1, the projection apparatus 2 is located on the opposite side of the light-incident-side light guide apparatus 3 to the Z-direction side and projects the display light flux described above in the Z direction. In contrast, in the virtual image display apparatus according to the present embodiment, the projection apparatus is located on the Y-direction side of the light-incident-side light guide apparatus 3 and projects the display light flux described above in the direction opposite the Y direction. In this regard, the virtual image display apparatus according to the present embodiment differs from the virtual image display apparatus 1 described above. In the following description, portions that are the same or roughly the same as those having already been described have the same reference characters and will not be described.

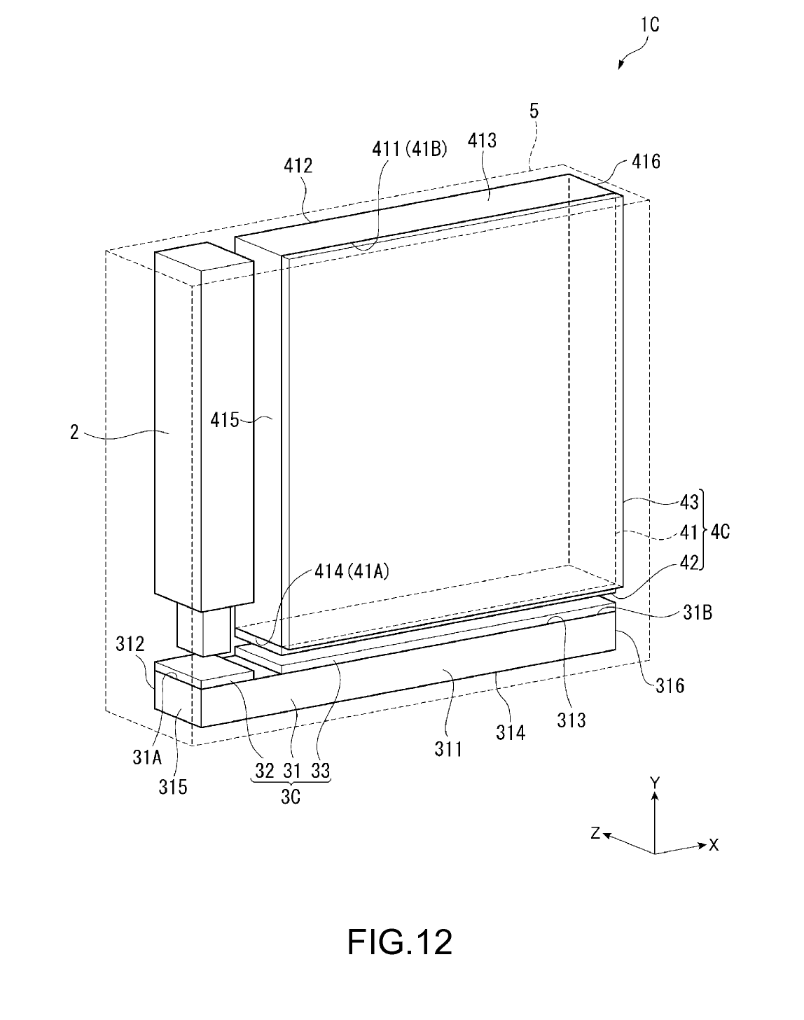

FIG. 12 is a perspective view showing a schematic configuration of a virtual image display apparatus 1C according to the present embodiment.

The virtual image display apparatus 1C according to the present embodiment includes the projection apparatus 2, a light-incident-side light guide apparatus 3C, a light-exiting-side light guide apparatus 4C, and an enclosure 5, which accommodates the apparatus described above, as shown in FIG. 12, and has the same function as that of the virtual image display apparatus 1 described above.

It is assumed in the present embodiment that the X, Y, and Z directions are oriented in the same manner as the X, Y, and Z directions shown in the first and second embodiments described above.

In the present embodiment, the projection apparatus 2 is located on the Y-direction side of the light-incident-side light guide apparatus 3C so that the direction in which the display light flux is projected is opposite the Y direction.

The light-incident-side light guide apparatus 3C includes the light-incident-side light guide 31, the longitudinal axis of which extends along the X direction, the light-incident-side diffraction grating 32, and the light-exiting-side diffraction grating 33, as the light-incident-side light guide apparatus 3 described above does. In the present embodiment, however, the light-incident-side diffraction grating 32 is so attached that it covers the light incident surface 31A, which is an area of the Y-direction-side third surface 313 of the light-incident-side light guide 31 and located on the side opposite the X-direction side, and the light-exiting-side diffraction grating 33 is so attached that it covers the light exiting surface 31B, which is an area of the third surface 313 on the X-direction side. A total reflection layer is formed over each of the surfaces 311, 312, and 314 to 316 and on the third surface 313 except the light incident surface 31A and the light exiting surface 31B. That is, the light-incident-side light guide apparatus 3C has the same configuration as that of the light-incident-side light guide apparatus 3 with the first surface 311 of the light-incident-side light guide 31 facing the Y-direction side.

The display light flux projected from the projection apparatus 2 toward the thus configured light-incident-side light guide apparatus 3C enters the light-incident-side light guide 31 via the light-incident-side diffraction grating 32 and the light incident surface 31A, each of which faces the Y-direction side, travels toward the X-direction side while repeatedly undergoing internal reflection, and exits via the light exiting surface 31B and the light-exiting-side diffraction grating 33, each of which also faces the Y-direction side, toward the light-exiting-side light guide apparatus 4C.

The light-exiting-side light guide apparatus 4C includes the light-exiting-side light guide 41, which has a roughly rectangular plate-like shape and disposed along the XY plane, the light-incident-side diffraction grating 42, and the light-exiting-side diffraction grating 43, as the light-exiting-side light guide apparatus 4 described above does. In the present embodiment, however, the light-incident-side diffraction grating 42 is attached to the fourth surface 414 of the light-exiting-side light guide 41, the surface on the side opposite the Y-direction side, and the fourth surface 414 serves as the light incident surface 41A of the light-exiting-side light guide 41. The light-exiting-side diffraction grating 43 is attached to the first surface 411 of the light-exiting-side light guide 41, the surface on the side opposite the Z-direction side, and the first surface 411 serves as the light exiting surface 41B of the light-exiting-side light guide 41.

A total reflection layer is formed over each of the other surfaces 412, 413, 415, and 416.

In the thus configured light-exiting-side light guide apparatus 4C, light that comes from the light-exiting-side diffraction grating 33 via the light-incident-side diffraction grating 42 and enters the light-exiting-side light guide 41 travels toward the Y-direction side while repeatedly undergoing internal reflection at the surfaces 411 to 413, 415, and 416, on each of which the total reflection film is formed (primarily between second surface 412 and light exiting surface 41B). In this process, part of the light (predetermined proportion of the light) having reached the light exiting surface 41B exits through the light exiting surface 41B, and the other part of the light undergoes internal reflection at the light exiting surface 41B, further travels toward the Y-direction side, and is incident on the light exiting surface 41B again, as in the case described above. The light having thus exited through the light exiting surface 41B exits out of the virtual image display apparatus 1C via the light-exiting-side diffraction grating 43.

An image thus formed by the light that exited from the virtual image display apparatus 1C described above is visually recognized in the form of a virtual image in multiple viewing positions in the X and Y directions, as in the case of an image formed by the light that exited from the virtual image display apparatus 1 described above.

### Advantageous Effects Provided by Third Embodiment

The virtual image display apparatus 1C according to the present embodiment described above can provide the same advantageous effects as those provided by the virtual image display apparatus 1 described above.

The light-exiting-side diffraction gratings 33 and 43 provided in the thus configured virtual image display apparatus 1C may have the characteristic shown in the variation of the first embodiment described above. Further, the virtual image display apparatus 1C may include the transmitted light level adjustment layers 34 and 44 described above. In these cases, the following advantageous effect can be provided: Images having roughly the same luminance can be visually recognized in any viewing positions. Further, the direction adjustment layer 45 described above may be disposed on the light exiting side of the light-exiting-side diffraction grating 43.

### Fourth Embodiment

A fourth embodiment of the invention will next be described.

A virtual image display apparatus according to the present embodiment has a configuration similar to that of the virtual image display apparatus 1B described above. In the virtual image display apparatus 1B, the light-incident-side diffraction gratings 32 and 42 and the light-exiting-side diffraction gratings 33 and 43 are each formed of a transmissive diffraction grating and disposed in positions where they face the light incident surfaces 31A and 41A and the light exiting surfaces 31B and 41B, respectively. In contrast, in the virtual image display apparatus according to the present embodiment, the light-incident-side diffraction gratings and the light-exiting-side diffraction gratings are each formed of a reflective diffraction grating and located differently with respect to the light-incident-side light guide 31 and the light-exiting-side light guide 41. In this regard, the virtual image display apparatus according to the present embodiment differs from the virtual image display apparatus 1B described above. In the following description, portions that are the same or roughly the same as those having already been described have the same reference characters and will not be described.

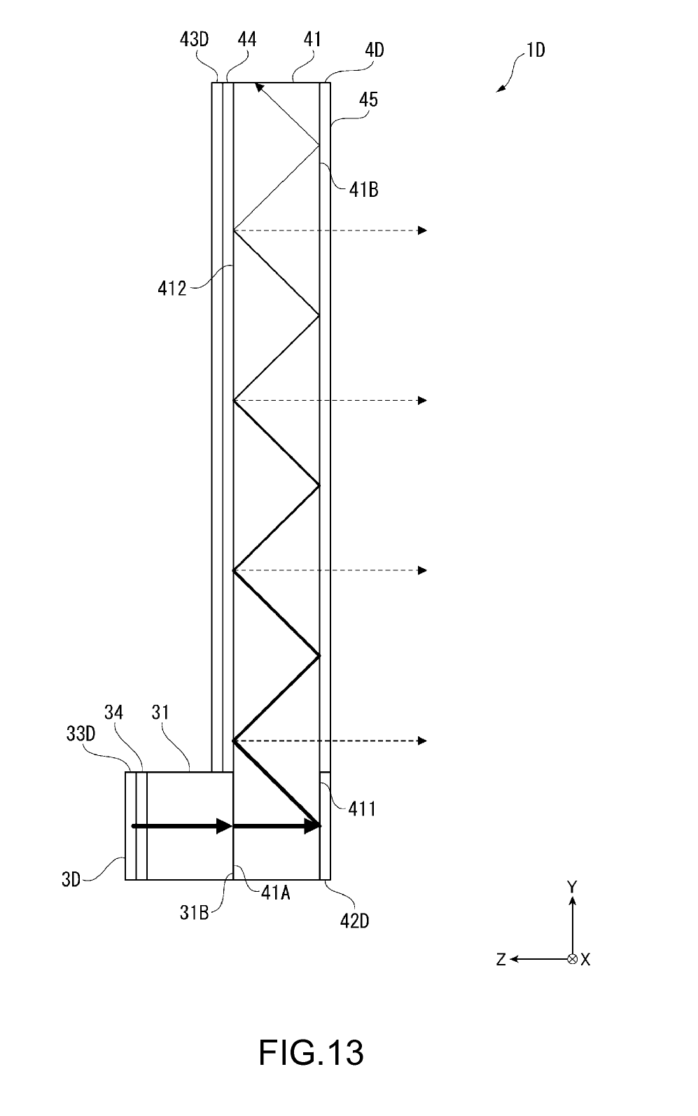

FIG. 13 is a diagrammatic view showing the configuration of a virtual image display apparatus 1D according to the present embodiment and the optical paths of light rays that exited from the virtual image display apparatus 1D.

The virtual image display apparatus 1D according to the present embodiment includes the projection apparatus 2 (not shown), a light-incident-side light guide apparatus 3D, on which a display light flux is incident from the projection apparatus 2, and a light-exiting-side light guide apparatus 4D, on which the display light flux is incident via the light-incident-side light guide apparatus 3D, and has the same function as that of the virtual image display apparatus 1B.

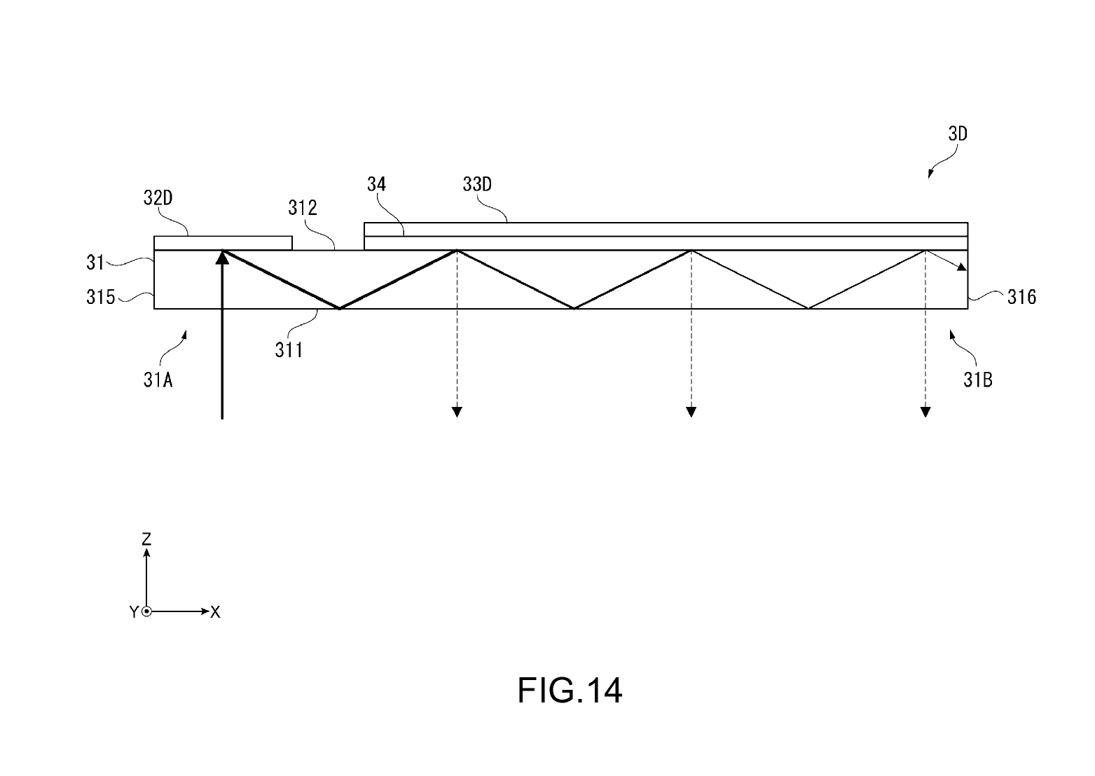

FIG. 14 is a diagrammatic view showing the configuration of the light-incident-side light guide apparatus 3D and the optical path of a light ray that passes through the light-incident-side light guide apparatus 3D.

The light-incident-side light guide apparatus 3D includes the light-incident-side light guide 31, which corresponds to the second light guide, a light-incident-side diffraction grating 32D, which corresponds to the second light-incident-side diffraction grating, a light-exiting-side diffraction grating 33D, which corresponds to the second light-exiting-side diffraction grating, and the transmitted light level adjustment layer 34, as shown in FIG. 14, and has the same function as that of the light-incident-side light guide apparatus 3A described above.

The light-incident-side light guide 31 is so formed that it has a roughly rectangular columnar shape with the longitudinal axis thereof extending along the X direction, as described above. The first surface 311 of the light-incident-side light guide 31 has an area on the side opposite the X-direction side, and the area is set to be the light incident surface 31A, on which a display light flux is incident from the projection apparatus 2. The first surface 311 further has an area on the X-direction side, and the area is set to be the light exiting surface 31B, through which the display light flux exits toward the light-exiting-side light guide apparatus 4D. Among the surfaces 312 to 316 of the light-incident-side light guide 31, a total reflection layer is formed on each of the surfaces 313 to 316, but no total reflection layer is formed on the first surface 311 or the second surface 312, which is located on the side opposite the first surface 311, except part of the first and second surfaces 311 and 312 (except portion between light-incident-side diffraction grating 32D and light-exiting-side diffraction grating 33D/transmitted light level adjustment layer 34).

The light-incident-side diffraction grating 32D is formed of a reflective diffraction grating and disposed in a position where it faces the second surface 312. In detail, the light-incident-side diffraction grating 32D is disposed in a position where it faces the light incident surface 31A with the light-exiting-side light guide 31 interposed therebetween. The display light flux having entered the light-incident-side light guide 31 through the light incident surface 31A is incident on the light-incident-side diffraction grating 32D. The light-incident-side diffraction grating 32D diffracts light rays that form the incident display light flux at angles of diffraction according not only to the wavelengths of the light rays but also to the angles of incidence of the light rays incident on the light incident surface of the light-incident-side diffraction grating 32D and reflects the light rays in such a way that the reflected light rays are incident on the other surfaces of the light-incident-side light guide 31 (first surface 311, for example) at angles greater than or equal to the critical angle associated therewith. The light rays reflected off the thus configured light-incident-side diffraction grating 32D travel toward the X-direction side while repeatedly undergoing internal reflection in the light-incident-side light guide 31.

The light-exiting-side diffraction grating 33D is formed of a reflective diffraction grating having the same characteristic as that of the light-incident-side diffraction grating 32D described above in terms of diffraction of incident light, and the light-exiting-side diffraction grating 33D is disposed in a position where it faces the second surface 312. In detail, the light-exiting-side diffraction grating 33D is disposed in a position where it faces the light exiting surface 31B described above with the light-incident-side light guide 31 interposed therebetween. Part of the light traveling in the light-incident-side light guide 31 toward the X-direction side and incident on the second surface 312 is incident on the light-exiting-side diffraction grating 33D. The light-exiting-side diffraction grating 33D diffracts and reflects the light incident thereon in accordance with the wavelength of the light and the angle of incidence thereof with respect to the light incident surface of the light-exiting-side diffraction grating 33D. The light diffracted by the light-exiting-side diffraction grating 33D is incident on the light exiting surface 31B at an angle smaller than the critical angle associated with the light exiting surface 31B described above and exits out of the light-incident-side light guide apparatus 3D through the light exiting surface 31B.

The transmitted light level adjustment layer 34 is disposed between the second surface 312 and the light-exiting-side diffraction grating 33D. The transmitted light level adjustment layer 34 causes part of the light incident thereon to pass therethrough and enter the light-exiting-side diffraction grating 33D whereas causing the other part of the light to be reflected at an angle equal to the angle of incidence of the light having been incident on the transmitted light level adjustment layer 34. The transmitted light level adjustment layer 34 has a characteristic in which the reflectance at which it reflects the light incident thereon decreases with distance in the X direction.

The display light flux having originated from the projection apparatus 2 through the light incident surface 31A and entered the thus configured light-incident-side light guide apparatus 3D is diffracted by and reflected off the light-incident-side diffraction grating 32D and travels in the X direction in the light-incident-side light guide 31 while repeatedly undergoing internal reflection. Part of the display light flux having reached the second surface 312 is reflected off the transmitted light level adjustment layer 34 and further travels in the X direction, repeatedly undergoes internal reflection, and reaches the second surface 312 again. On the other hand, the other part of the display light flux having reached the second surface 312 is incident on the light-exiting-side diffraction grating 33D via the transmitted light level adjustment layer 34 and diffracted by and reflected off the light-exiting-side diffraction grating 33D. The light reflected off the light-exiting-side diffraction grating 33D exits through the light exiting surface 31B, which is located on the side opposite the second surface 312, in the direction opposite the Z direction and enters the light-exiting-side light guide apparatus 4D. In this process, since the transmitted light level adjustment layer 34 is characterized in that the reflectance thereof decreases in the X direction, the light incident on the light-exiting-side diffraction grating 33D is roughly fixed along the X direction, whereby the amount of light that exited from the light-incident-side light guide apparatus 3D can be made uniform along the X direction.

The light-exiting-side light guide apparatus 4D includes the light-exiting-side light guide 41, which corresponds to the first light guide, a light-incident-side diffraction grating 42D, which corresponds to the first light-incident-side diffraction grating, a light-exiting-side diffraction grating 43D, which corresponds to the first light-exiting-side diffraction grating, the transmitted light level adjustment layer 44, and the direction adjustment layer 45 and has the same function as that of the light-exiting-side light guide apparatus 4B described above.

The light-exiting-side light guide 41 is so formed that it has a roughly rectangular plate-like shape extending along the XY plane, as described above. The Z-direction-side second surface 412 of the light-exiting-side light guide 41 has an area on the side opposite the Y-direction side, and the area is set to be the light incident surface 41A, on which the display light flux is incident from the light-incident-side light guide apparatus 3D. The first surface 411, which faces away from the second surface 412, has an area on the Y-direction side, and the area is set to be the light exiting surface 41B, through which the display light flux having traveled in the light-exiting-side light guide 41 exits to the outside so that an image formed by the display light flux is allowed to be visually recognized. Further, a total reflection layer is formed on each of the surfaces 413 to 416 of the light-exiting-side light guide 41, but no total reflection layer is formed on the first surface 411 or the second surface 412.

The light-incident-side diffraction grating 42D is formed of a reflective diffraction grating and disposed in a position where it faces an area of the first surface 411 on the side opposite the Y-direction side. In detail, the light-incident-side diffraction grating 42D is disposed in a position where it faces the light incident surface 41A with the light-exiting-side light guide 41 interposed therebetween. The display light flux having entered the light-exiting-side light guide 41 through the light incident surface 41A is incident on the light-incident-side diffraction grating 42D. The light-incident-side diffraction grating 42D diffracts light rays that form the incident display light flux at angles of diffraction according not only to the wavelengths of the light rays but also to the angles of incidence of the light rays incident on the light incident surface of the light-incident-side diffraction grating 42D and reflects the light rays in such a way that the reflected light rays are incident on the other surfaces of the light-exiting-side light guide 41 (second surface 412, for example) at angles greater than or equal to the critical angle associated therewith. The light rays reflected off the thus configured light-incident-side diffraction grating 42D travels toward the Y-direction side while repeatedly undergoing internal reflection in the light-exiting-side light guide 41.

The light-exiting-side diffraction grating 43D is formed of a reflective diffraction grating having the same characteristic as that of the light-incident-side diffraction grating 42D described above in terms of diffraction of incident light, and the light-exiting-side diffraction grating 43D is disposed in a position where it faces an area of the second surface 412 on the Y-direction side. In detail, the light-exiting-side diffraction grating 43D is disposed in a position where it faces the light exiting surface 41B with the light-exiting-side light guide 41 interposed therebetween. Part of the light traveling in the light-exiting-side light guide 41 toward the Y-direction side and incident on the second surface 412 is incident on the light-exiting-side diffraction grating 43D. The light-exiting-side diffraction grating 43D diffracts and reflects the light incident thereon in accordance with the wavelength of the light and the angle of incidence thereof with respect to the light incident surface of the light-exiting-side diffraction grating 43D. The light diffracted by the light-exiting-side diffraction grating 43D is incident on the light exiting surface 41B at an angle smaller than the critical angle associated with the light exiting surface 41B described above and exits out of the light-exiting-side light guide apparatus 4D through the light exiting surface 41B and eventually out of the virtual image display apparatus 1D.

The transmitted light level adjustment layer 44 is disposed between the second surface 412 and the light-exiting-side diffraction grating 43D. The transmitted light level adjustment layer 44 causes part of the light incident thereon to pass therethrough and enter the light-exiting-side diffraction grating 43D whereas causing the other part of the light to be reflected at an angle equal to the angle of incidence of the light having been incident on the transmitted light level adjustment layer 44, as the transmitted light level adjustment layer 34 described above does. The transmitted light level adjustment layer 44 has a characteristic in which the reflectance at which it reflects the light incident thereon decreases with distance in the Y direction.

The direction adjustment layer 45 is located in a position corresponding to the light exiting surface 41B and on the light exiting side of the light exiting surface 41B. The direction adjustment layer 45 adjusts the traveling directions of all light rays that pass through the direction adjustment layer 45 in such a way that the central light described above (light that forms the center of an image formed by the display light flux) exits along the direction of a normal to the direction adjustment layer 45 (direction of normal to light exiting surface 41B).

The display light flux incident from the light-incident-side light guide apparatus 3D through the light incident surface 41A on the thus configured light-exiting-side light guide apparatus 4D is diffracted by and reflected off the light-incident-side diffraction grating 42D and travels in the Y direction in the light-exiting-side light guide 41 while repeatedly undergoing internal reflection. Part of the display light flux having reached the second surface 412 is reflected off the transmitted light level adjustment layer 44 and further travels in the Y direction, repeatedly undergoes internal reflection, and reaches the second surface 412 again. On the other hand, the other part of the display light flux having reached the second surface 412 is incident on the light-exiting-side diffraction grating 43D via the transmitted light level adjustment layer 44 and diffracted by and reflected off the light-exiting-side diffraction grating 43D. The light reflected off the light-exiting-side diffraction grating 43D exits through the light exiting surface 41B, which is located on the side opposite the second surface 412, in the direction opposite the Z direction, whereby the light exits out of the virtual image display apparatus 1D. In this process, since the transmitted light level adjustment layer 44 has a characteristic that the reflectance thereof decreases in the Y direction, the amounts of the light rays incident on the light-exiting-side diffraction grating 43D are substantially the same in the Y direction, whereby the amount of light exiting from the light-exiting-side light guide apparatus 4D, that is, the amount of light exiting from the virtual image display apparatus 1D can be made uniform along the X and Y directions.

### Advantageous Effects Provided by Fourth Embodiment

The virtual image display apparatus 1D according to the present embodiment described above can provide the same advantageous effects as those provided by the virtual image display apparatus 1B described above.

In the virtual image display apparatus 1D described above, the direction adjustment layer 45 may be omitted. On the other hand, each of the diffraction gratings 32D, 33D, 42D, and 43D may be provided with a characteristic in which the diffraction efficiency described above increases. Further, a layer having a predetermined optical characteristic may be so located on each of the light exiting surfaces 31B and 41B that the light traveling in the light guides 31 and 41 while repeatedly undergoing internal reflection and the light diffracted by the light-exiting-side diffraction gratings 33D and 43D are allowed to exit separately from each other.

### Variations of Embodiments

The invention is not limited to the embodiments described above, and changes, improvements, and other modifications to the extent that they achieve the advantage of some aspects of the invention fall within the scope of the invention.

In each of the embodiments described above, the virtual image display apparatus 1, 1A to 1D include the light-incident-side light guide apparatus 3, 3A, 3C, and 3D, each of which disperses the light emitted from the projection apparatus 2 in the X direction and allows the dispersed light to exit, and the light-exiting-side light guide apparatus 4, 4A to 4D, each of which disperses the light incident from the light-incident-side light guide apparatus 3, 3A, 3C, and 3D in the Y direction and allows the dispersed light to exit, respectively. The invention is, however, not necessarily configured this way. That is, the virtual image display apparatus may be formed of the projection apparatus 2 and any one of the light-incident-side light guide apparatus 3, 3A, 3C, and 3D and any one of the light-exiting-side light guide apparatus 4, 4A to 4D.

For example, the light-incident-side light guide apparatus 3 disperses the display light flux incident from the projection apparatus 2 in the X direction, which is the longitudinal direction of the light-incident-side light guide apparatus 3, and allows the dispersed light to exit, as shown in FIGS. 4 and 5. Therefore, viewers present in a plurality of viewing positions set along the X direction on the light exiting side of the light-incident-side light guide apparatus 3 can visually recognize an image formed by the display light flux projected from the projection apparatus 2 in the form of a virtual image.

The light-incident-side light guide apparatus 3 may not be so disposed that the longitudinal axis thereof extends along the X direction and may, for example, be so disposed that the longitudinal axis thereof extends along the Y direction.

On the other hand, the light-exiting-side light guide apparatus 4 receives the light dispersed in the X direction by the light-incident-side light guide apparatus 3, disperses the light in the Y direction, and allows the dispersed light to exit, as shown in FIG. 7. Therefore, when the display light flux described above is incident on the light-incident-side diffraction grating 42 in the light-exiting-side light guide apparatus 4, viewers present in a plurality of viewing positions set along the Y direction on the light exiting side of the light-exiting-side light guide apparatus 4 can visually recognize an image formed by the display light flux projected from the projection apparatus 2 in the form of a virtual image. Further, when the same or different images are incident on the light-incident-side diffraction grating 42 in such a way that the images do not overlap with each other, the same or different images can be visually recognized in the form of virtual images in viewing positions set in different positions along the X direction.

In the first to third embodiment described above, the light-incident-side diffraction gratings 32 and 42 are disposed in the positions where they face the light incident surfaces 31A and 41A of the light-incident-side light guide and the light-exiting-side light guide 41, and the light-exiting-side diffraction gratings 33 and 43 are disposed in the positions where they face the light exiting surfaces 31B and 41B of the light-incident-side light guide 31 and the light-exiting-side light guide 41. Each of the diffraction gratings 32, 33, 42, and 43 is formed of a transmissive diffraction grating. In the fourth embodiment described above, the light-incident-side diffraction gratings 32D and 42D are disposed in the positions where they face the light incident surfaces 31A and 41A with the light guides 31 and 41 interposed therebetween, and the light-exiting-side diffraction gratings 33D and 43D are disposed in the positions where they faces the light exiting surfaces 31B and 41B with the light guides 31 and 41 interposed therebetween. Each of the diffraction gratings 32D, 33D, 42D, and 43D is formed of a reflective diffraction grating. The invention is, however, not necessarily configured this way. That is, one of the two diffraction gratings employed in each of the light-incident-side light guide apparatus and the light-exiting-side light guide apparatus may be a transmissive diffraction grating, and the other may be a reflective diffraction grating. Further, one of the light-incident-side light guide apparatus and the light-exiting-side light guide apparatus may have two transmissive diffraction gratings and the other may have two reflective diffraction gratings. That is, the characteristics and arrangement of the diffraction gratings in each of the light guide apparatus can be changed as appropriate.

In each of the embodiments described above, the light-incident-side diffraction gratings 32 and 32D and the light-exiting-side diffraction gratings 33 and 33D diffract light fluxes having the same wavelength at the same angle of diffraction, and the same holds true for the light-incident-side diffraction gratings 42 and 42D and the light-exiting-side diffraction gratings 43 and 43D. The invention is, however, not necessarily configured this way. That is, the light-incident-side diffraction gratings 32 and 32D and the light-exiting-side diffraction gratings 33 and 33D may diffract light fluxes at different angles of diffraction, and the light-incident-side diffraction gratings 42 and 42D and the light-exiting-side diffraction gratings 43 and 43D may diffract light fluxes at different angles of diffraction.

In each of the embodiments described above, the light exiting surface 31B of the light-incident-side light guide 31 and the light incident surface 41A of the light-exiting-side light guide 41 are so disposed that they face each other. The invention is, however, not necessarily configured this way. For example, the light having exited through the light exiting surface 31B may be guided to the light incident surface 41A via a prism or any other light guide member.

In the first to third embodiment described above, the light-exiting-side light guide apparatus 3, which guides the display light flux to the light-exiting-side light guide apparatus 4, which allows light to exit toward viewers, includes the light-incident-side diffraction grating 32, which causes the display light flux to be incident on the light incident surface 31A of the light-incident-side light guide 31, and the light-exiting-side diffraction grating 33, which diffracts the display light flux incident through the light exiting surface 31B of the light-incident-side light guide 31. Further, in the fourth embodiment described above, the light-incident-side light guide apparatus 3D, which guides the display light flux to the light-exiting-side light guide apparatus 4D, which allows light to exit toward viewers, includes the light-incident-side diffraction grating 32D, which diffracts and reflects the display light flux incident through the light incident surface 31A in such a way that the display light flux repeatedly undergoes internal reflection in the light-incident-side light guide 31 and travels in the X direction, and the light-exiting-side diffraction grating 33D, which diffracts the display light flux incident from the light-incident-side light guide 31 in such a way that the display light flux exits to the outside through the light exiting surface 41B, which faces the light-exiting-side diffraction grating 33D. The invention is, however, not necessarily configured this way. For example, in place of the light-incident-side light guide apparatus 3, 3A, 3C, and 3D, the following configuration may be employed: No diffraction grating 32 or 33 is provided, but a plurality of semi-transparent layers (half-silvered mirrors) inclined to the light traveling direction are internally formed, and light rays separated by the plurality of semi-transparent layers are incident on the light-incident-side diffraction grating 42 in the light-exiting-side light guide apparatus 4 described above. Further, in the light-incident-side light guide apparatus 3, a partially reflective layer may be formed on the light-incident-side light guide 31 in place of the light-exiting-side diffraction grating 33. The configuration described above also allows the display light flux incident on the light-incident-side light guide 31 to travel in the longitudinal direction of the light guide 31 (direction along the central axis thereof) while causing the display light flux to undergo internal reflection and causes the display light flux to exit through the partially reflective layer in a dispersed manner.

In the second embodiment described above, the direction adjustment layer 45 is provided on the light exiting side of the light-exiting-side diffraction grating 43, which forms the light-exiting-side light guide apparatus 4B. The invention is, however, not necessarily configured this way. That is, the direction adjustment layer 45 is not necessarily provided. On the other hand, the direction adjustment layer 45 may be provided in the light-incident-side light guide apparatus. In this case, the direction adjustment layer 45 may be disposed on the light exiting side of the light exiting surface 31B (when the light-exiting-side diffraction grating 33 is disposed on the light exiting side of the light exiting surface 31B, the direction adjustment layer 45 may be disposed on the light exiting side of the light-exiting-side diffraction grating 33).

Further, in the virtual image display apparatus 1A, the transmitted light level adjustment layers 34 and 44 are disposed between the light exiting surface 31B of the light-incident-side light guide 31 and the light-exiting-side diffraction grating 33 in the light-incident-side light guide apparatus 3 and between the light exiting surface 41B of the light-exiting-side light guide 41 and the light-exiting-side diffraction grating 43 in the light-exiting-side light guide apparatus 4, respectively. In the virtual image display apparatus 1D, the transmitted light level adjustment layers 34 and 44 are disposed between the second surface 312 of the light-incident-side light guide 31 and the light-exiting-side diffraction grating 33D in the light-incident-side light guide apparatus 3D and between the second surface 412 of the light-exiting-side light guide 41 and the light-exiting-side diffraction grating 43D in the light-exiting-side light guide apparatus 4D, respectively. The invention is, however, not necessarily configured this way. The transmitted light level adjustment layer 34 and 44 may be omitted.

Further, the light-exiting-side diffraction gratings 33 and 34 have the diffraction efficiency increasing characteristic in which the ratio of the amount of transmitted light to the amount of incident light increases in the light traveling direction in the light guides provided with the diffraction gratings 33 and 43. The invention is, however, not necessarily configured this way. The diffraction gratings may not have the diffraction efficiency increasing characteristic.

In each of the embodiment described above, the light source apparatus 21, which forms the projection apparatus 2, emits a light flux containing color light rays classified into red, green, and blue and each having a wavelength width of 10 nm or wider. The invention is, however, not necessarily configured this way. That is, the color light rays contained in the light flux are not limited to the color light rays of red, green, and blue and may contain light rays classified into other colors, and the projection apparatus 2 may instead project a single-color light flux (display light flux formed of a color light ray classified into a single color) as long as it has a wavelength width of 10 nm or wider. Further, the light emitted from the light source apparatus 21 and eventually incident on the light-incident-side light guide apparatus 3, 3D and the light-exiting-side light guide apparatus 4, 4D may have a wavelength width of 10 nm or narrower or may be single-color light as long as the light can be separated by the light-incident-side diffraction gratings 32, 32D, 42, and 42D and allowed to exit to the light-exiting-side diffraction gratings 33, 33D, 43, and 43D in a dispersed manner.

In each of the embodiments described above, the light-incident-side light guide 31 and the light-exiting-side light guide 41 are made of glass, a resin, or any other light transmissive material and so formed that they have a roughly rectangular columnar shape and a roughly rectangular plate-like shape, respectively. That is, each of the light guides 31 and 41 is a solid body. The invention is, however, not necessarily configured this way. That is, at least one of the light-incident-side light guide 31 and the light-exiting-side light guide 41 may be a hollow body.

In each of the embodiments described above, an area of the first surface 411 of the light-exiting-side light guide 41 is set to be the light exiting surface 41B, through which light exits. The invention is, however, not necessarily configured this way. That is, the surface through which light exits in each of the light-incident-side light guide apparatus 3, 3A, 3C, and 3D and the light-exiting-side light guide apparatus 4, 4A to 4D may be any surface. For example, an area of the second surface 412 may be set to be the light exiting surface 41B. Further, a plurality of surfaces may have areas set to be the light exiting surfaces 31B and 41B. For example, an area of each of the first surface 411 and the second surface 412 may be set to be the light exiting surface 41B.

In the second and fourth embodiments described above, an area of the light incident surface 31A of the light-incident-side light guide 31 is set to be the first surface 311, and in the third embodiment described above, an area of the third surface 313 is set to be the light incident surface 31A. In the first, second, and fourth embodiments describe above, an area of the second surface 412 is set to be the light incident surface 41A of the light-exiting-side light guide 41, and in the third embodiment described above, an area of the fourth surface 414 is set to be the light incident surface 41A. The invention is, however, not necessarily configured this way. For example, an area of the second surface 312 may be set to be the light incident surface 31A of the light-incident-side light guide 31, and the entire area of the first surface 311 may be set to be the light exiting surface 31B. Further, as in the light-exiting-side light guide apparatus 4C, an area of the fourth surface 414 of the light-exiting-side light guide 41 may be set to be the light incident surface 41A, and the entire area of the first surface 411 may be set to be the light exiting surface 41B.

That is, the positions of the light incident surfaces 31A, 41A and the light exiting surfaces 31B, 41B in the light guide 31 and 41 can be set as appropriate.

In each of the embodiments described above, the virtual image display apparatus 1, 1A to 1D each include the projection apparatus 2, which projects display light flux that forms an image visually recognized by a viewer. The invention is, however, not necessarily configured this way. That is, each of the virtual image display apparatus may be so configured that the projection apparatus 2 is attached as a separate member to the virtual image display apparatus that functions as a screen.

The entire disclosure of Japanese Patent Application No. 2014-220043, filed Oct. 29, 2014 is expressly incorporated by reference herein.

What is claimed is:

1. A virtual image display apparatus comprising:
a first light guide that not only causes a display light flux incident through a first light incident surface to repeatedly undergo internal reflection to travel in a first direction away from the first light incident surface but also causes part of the display light flux to exit to the outside through areas of a first light exiting surface that is at least one of interfaces with the outside and extends in the first direction;
a first light-incident-side diffraction grating that diffracts light incident thereon to cause the diffracted light to enter the first light guide; and
a first light-exiting-side diffraction grating that diffracts light incident from the first light guide.

2. The virtual image display apparatus according to claim 1,
wherein the first light-incident-side diffraction grating and the first light-exiting-side diffraction grating diffract incident light fluxes having the same wavelength at the same angle of diffraction.

3. The virtual image display apparatus according to claim 1, further comprising
a second light guide that not only causes the display light flux incident through a second light incident surface to repeatedly undergo internal reflection to travel in a second direction roughly perpendicular to the first direction but also causes part of the display light flux to exit toward the first light incident surface through areas of a second light exiting surface that is at least one of the interfaces with the outside and extends in the second direction.

4. The virtual image display apparatus according to claim 3, further comprising:
a second light-incident-side diffraction grating that diffracts light incident thereon to cause the diffracted light to enter the second light guide; and
a second light-exiting-side diffraction grating that diffracts light incident from the second light guide.

5. The virtual image display apparatus according to claim 4,
wherein the second light exiting surface and the first light incident surface are disposed in positions where the two surfaces face each other, and
the second light-incident-side diffraction grating and the second light-exiting-side diffraction grating diffract incident light fluxes having the same wavelength at the same angle of diffraction.

6. The virtual image display apparatus according to claim 1, further comprising
a direction adjustment layer that is disposed in correspondence with the first light exiting surface and adjusts the traveling direction of the light that exits out of the first light guide.

7. The virtual image display apparatus according to claim 1,
wherein the first light-exiting-side diffraction grating has a characteristic in which diffraction efficiency thereof increases in the first direction.

8. The virtual image display apparatus according to claim 1, further comprising
a transmitted light level adjustment layer that is disposed on at least one of the light incident side and the light exiting side of the first light-exiting-side diffraction grating and has one of a characteristic in which transmittance at which the transmitted light level adjustment layer transmits light incident thereon increases in the first direction and a characteristic in which reflectance at which the transmitted light level adjustment layer reflects the light decreases in the first direction.

9. The virtual image display apparatus according to claim 1,
wherein the display light flux contains at least one type of color light having a wavelength width of 10 nm or wider.
